(19) United States
(12) Patent Application Publication
(10) Pub. No.: US 2014/0349637 A1
(43) Pub. Date: Nov. 27, 2014

(54) FACILITATING WIRELESS COMMUNICATION IN CONJUNCTION WITH ORIENTATION POSITION

(71) Applicant: Elwha LLC, a limited liability corporation of the State of Delaware, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Douglas O. Reudink, Port Townsend, WA (US); Clarence T. Tegreene, Mercer Island, WA (US)

(73) Assignee: Elwha LLC, a limited liability corporation of the State of Delaware, Bellevue, WA (US)

(21) Appl. No.: 13/904,970

(22) Filed: May 29, 2013

Related U.S. Application Data
(63) Continuation-in-part of application No. 13/902,585, filed on May 24, 2013.
Application No. 13/902,585 is a continuation of application No. 13/842,040, filed on Mar. 15, 2013.

(51) Int. Cl. H04W 8/22

(52) U.S. Cl. CPC H04W 8/22
USPC 455/419

(57) ABSTRACT

Disclosed herein are example embodiments for facilitating wireless communication in conjunction with orientation position. For certain example embodiments, at least one device, such as a fixed node: (i) may obtain one or more antenna assembly configuration parameters that are associated with at least one orientation position of at least one portable wireless node; or (ii) may manage one or more antenna assembly configuration parameters that are associated with at least one orientation position of at least one portable wireless node. However, claimed subject matter is not limited to any particular described embodiments, implementations, examples, or so forth.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

(1) For purposes of the USPTO extra-statutory requirements, the present application constitutes a continuation-in-part of U.S. patent application Ser. No. 13/842,040, entitled “Frequency Accommodation”, naming Roderick A. Hyde, Royce A. Levien, Richard T. Lord, Robert W. Lord Mark A. Malamud, O. Reudink, and Clarence T. Tegreene as inventors, filed 15 Mar. 2013 (with Atty. Docket No. SE1-0855-US), which is currently co-pending or is an application of which a currently co-pending application is entitled to the benefit of the filing date.

(2) For purposes of the USPTO extra-statutory requirements, the present application constitutes a continuation-in-part of U.S. patent application Ser. No. 13/902,585, entitled “Facilitating Wireless Communication in Conjunction with Orientation Position”, naming Roderick A. Hyde, Royce A. Levien, Richard T. Lord, Robert W. Lord Mark A. Malamud, Douglas O. Reudink, and Clarence T. Tegreene as inventors, filed 24 May 2013 (with Atty. Docket No. SE1-0856-US), which is currently co-pending or is an application of which a currently co-pending application is entitled to the benefit of the filing date.

### RELATED APPLICATIONS

(1) U.S. patent application Ser. No. 13/317,338, entitled “Surface Scattering Antennas”, naming Adam Bily, Anna K. Boardman, Russell J. Hannigan, John Hunt, Nathan Kundtz, David R. Nash, Ryan Allan Stevenson, and Philip A. Sullivan as inventors, filed 14 Oct. 2011 (with Docket No. 0209-011-001-000000), is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BRIEF DESCRIPTION OF THE FIGURES

FIG. 1 is a block diagram indicative of a spatial relationship or interconnectedness of drawing sheets that respectively correspond to FIGS. 1A-1L, which together depict at least an example enviro-system related to certain example embodiments.

FIG. 1A is a schematic diagram of example wireless nodes in accordance with certain example embodiments.

FIGS. 1B-1L are individual schematic diagrams that may be combined to form a joint schematic diagram illustrating example implementations for accommodating one or more different frequencies in a wireless environment in accordance with certain example embodiments.

FIG. 2 is a schematic diagram of an example portable wireless node including one or more example components in accordance with certain example embodiments.

FIG. 3 is a schematic diagram of an example fixed node, such as a fixed wireless node or a fixed wired node, including one or more example components in accordance with certain example embodiments.

FIG. 4A is a schematic diagram that includes at least one example device, such as a fixed node, that is capable of handling scenarios for facilitating wireless communication in conjunction with orientation position in accordance with certain example embodiments.

FIGS. 4B-4D are schematic diagrams that include at least one example device and that depict example scenarios for facilitating wireless communication in conjunction with orientation position in accordance with certain example embodiments.

FIG. 5 is a flow diagram illustrating an example method for at least one device with regard to facilitating wireless communication in conjunction with orientation position in accordance with certain example embodiments.

FIGS. 6A1-6G (e.g., 6A1, 6A2, 6A3, 6B, 6C, 6D1, 6D2, 6E, 6F, and 6G) depict example additions or alternatives for a flow diagram of FIG. 5 in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

For certain example embodiments, one or more wireless communication parameters may be adopted by a mobile device based at least partially on a physical state of a mobile device to strengthen, enhance, improve, or a combination thereof, etc. a communication channel between a mobile device and another wireless device, such as a base station. Additionally or alternatively, a physical state of (e.g., a location of or an orientation of) a mobile device may be altered to strengthen, enhance, improve, or a combination thereof, etc. a communication channel between a mobile device and an another device, such as a base station (e.g., orientation of at least one communicating device may be altered to strengthen, enhance, improve, or a combination thereof, etc. a communication channel between/among one or more wireless devices).

For certain example embodiments, a physical state of a mobile device may include a spatial location of the mobile device or an orientation of the mobile device. For certain example implementations, a spatial location (e.g., which may be merged with or incorporated into or linked to 3-D mapping data, including those of buildings) may be represented with a geographical position of a mobile device (e.g., with regard to a point on the earth) or an elevation of a mobile device (e.g., with regard to a height above the earth). For certain example implementations, an orientation may be represented with (1) Euler angles or rotations or (2) pitch, roll, or yaw in 3-D Euclidean space.

For certain example embodiments, one or more wireless communication parameters, such as one or more antenna assembly configuration parameters, may include, but are not limited to any one or more of the following. First, an antenna element set may be selected from among multiple antenna elements of an antenna array. Second, a particular phase or delay may be applied to each antenna element of a selected set of antenna elements. Third, a particular power may be applied to each antenna element of a selected set of antenna elements. Fourth, a phased array antenna (e.g., which may be formed from multiple antenna elements comprising or including a single dipole) may include multiple antenna elements that are driven with particular signal values. For instance, different elements (e.g., if an element is covered/blocked), phases/delays, power, or a combination thereof, etc. may be applied to input/output connections of a phased array antenna (e.g., to establish or form a beam). Antennas, including but not limited to antenna arrays or phased arrays, may comprise or include or be formed or constructed using meta-materials. Fifth, a frequency of wireless signal(s) coupled to or from an antenna may be adjusted. Sixth, a frequency band or a wireless communication standard that is being employed may be altered, including but not limited to using a different antenna to support a different frequency band or wireless communication standard.

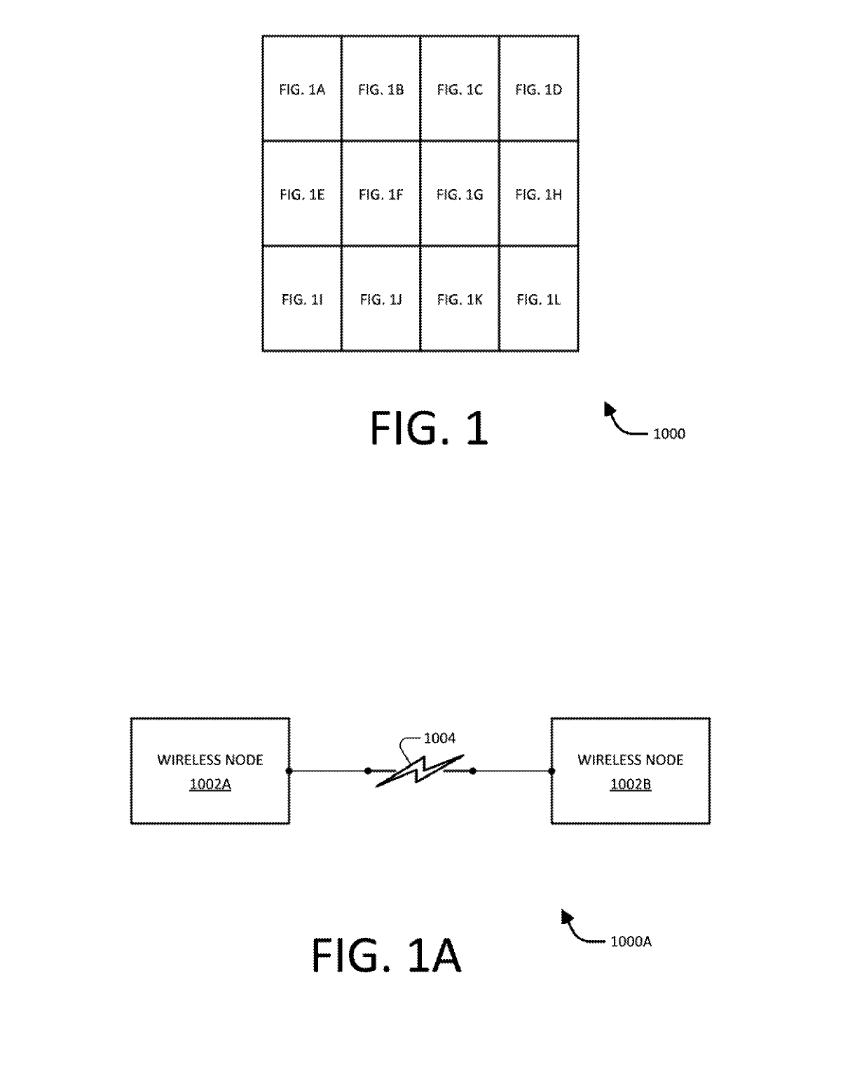

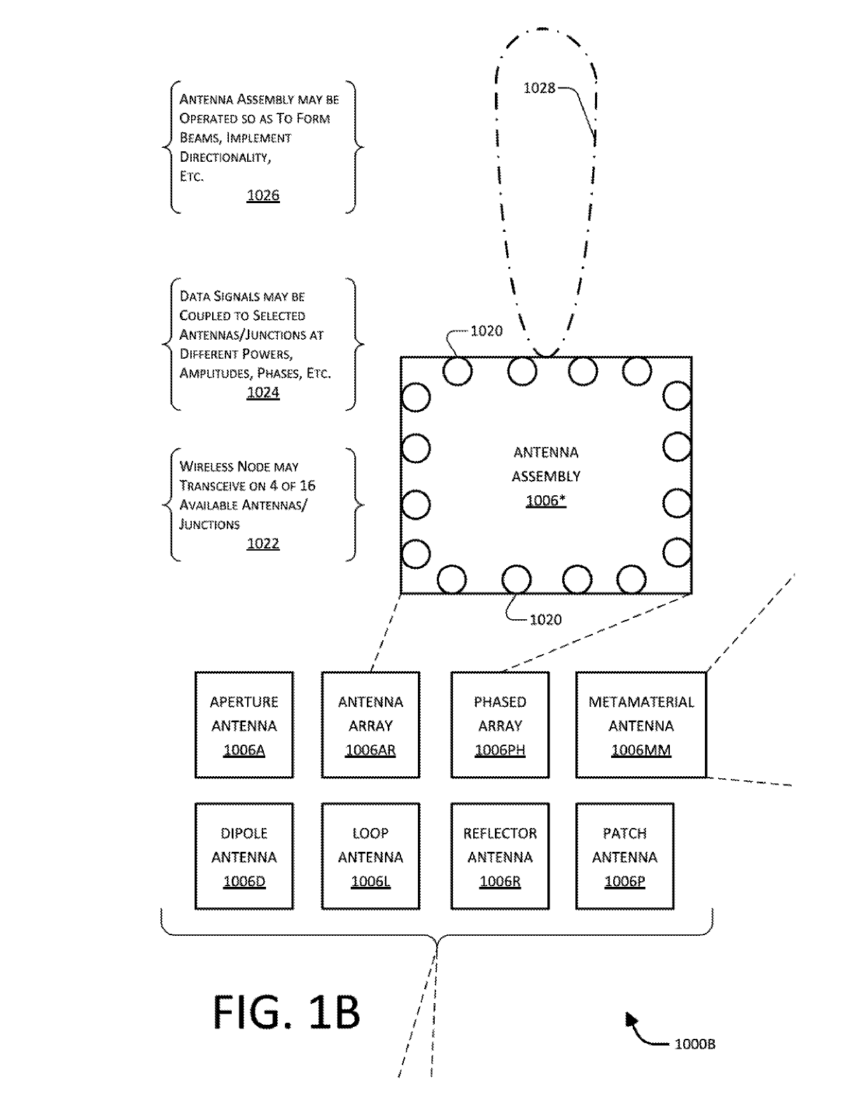

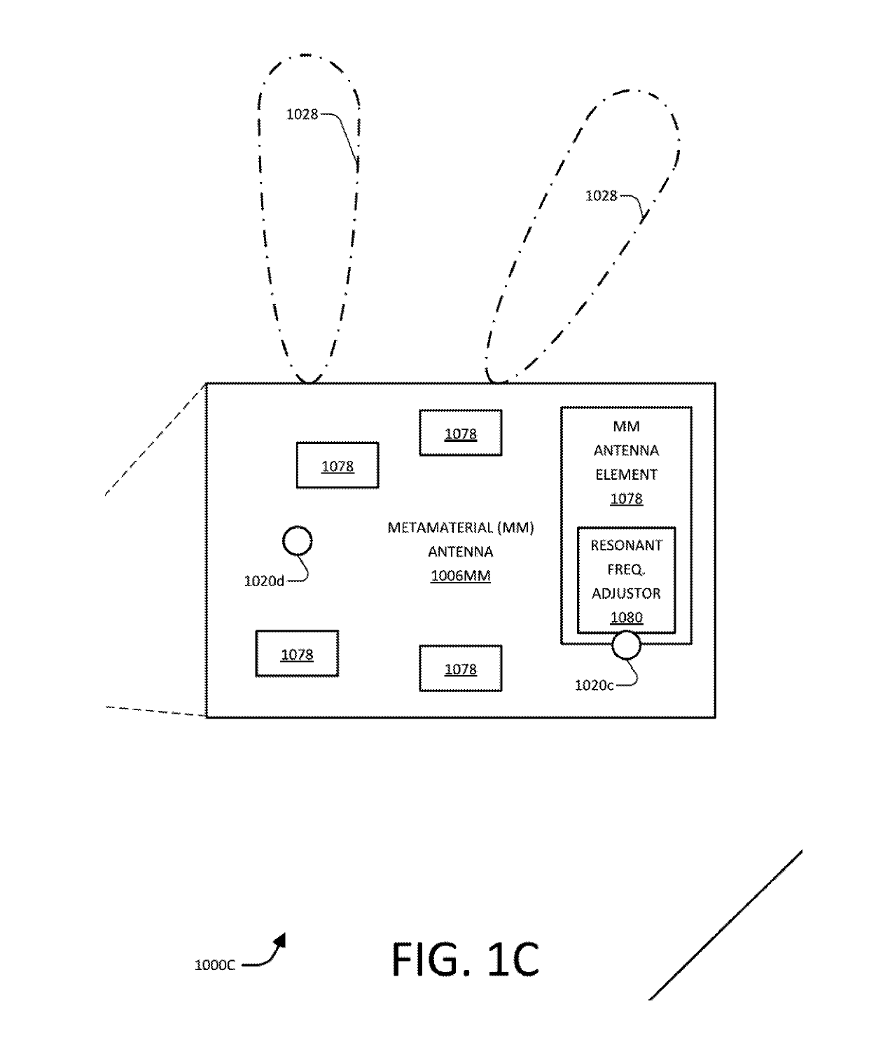

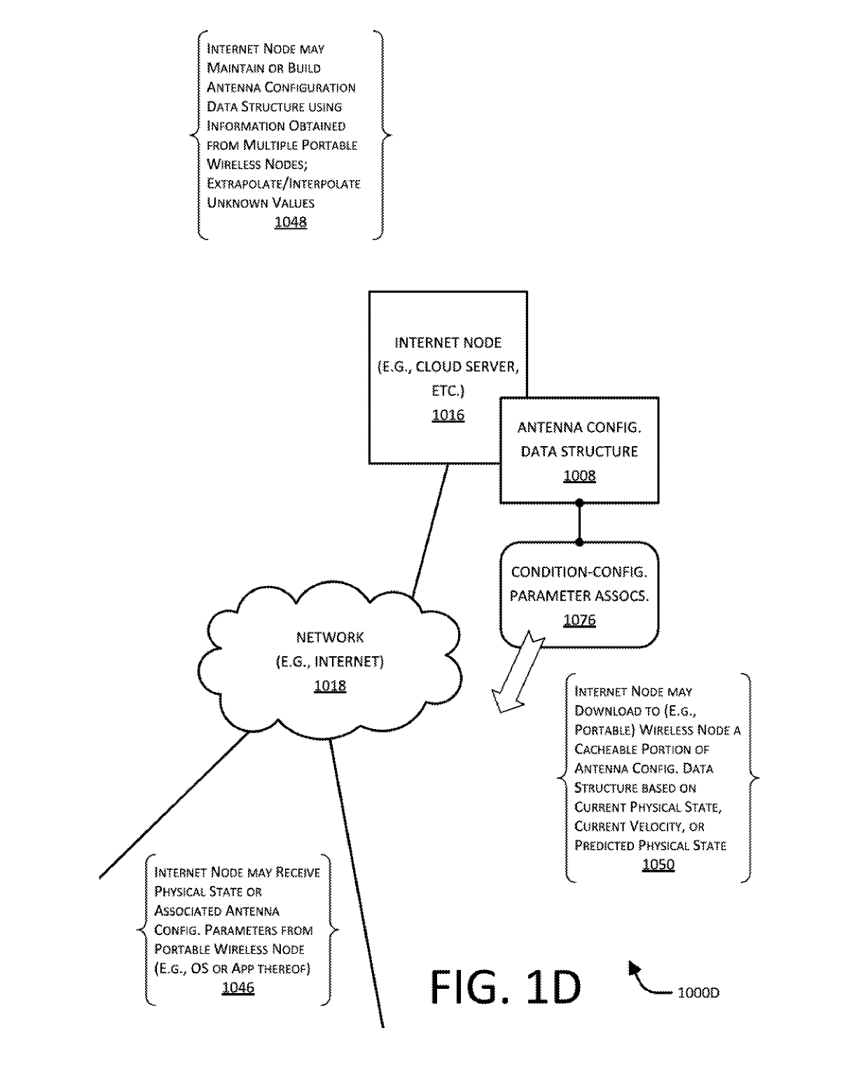

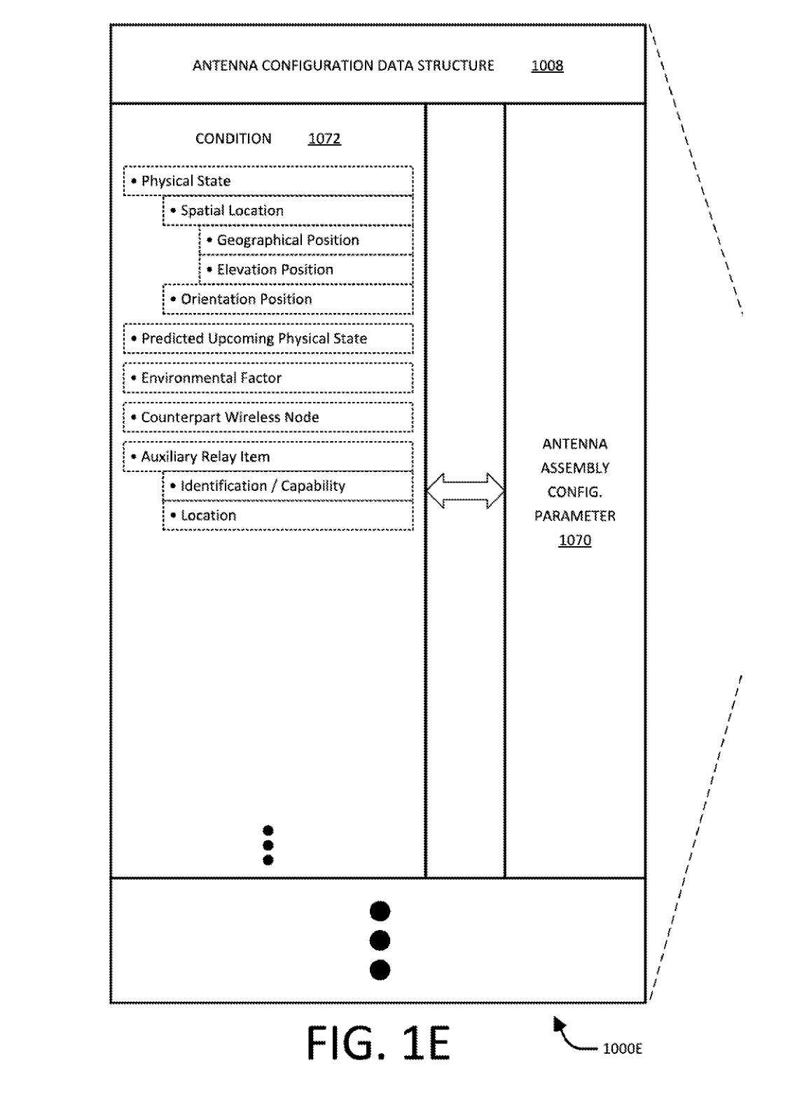

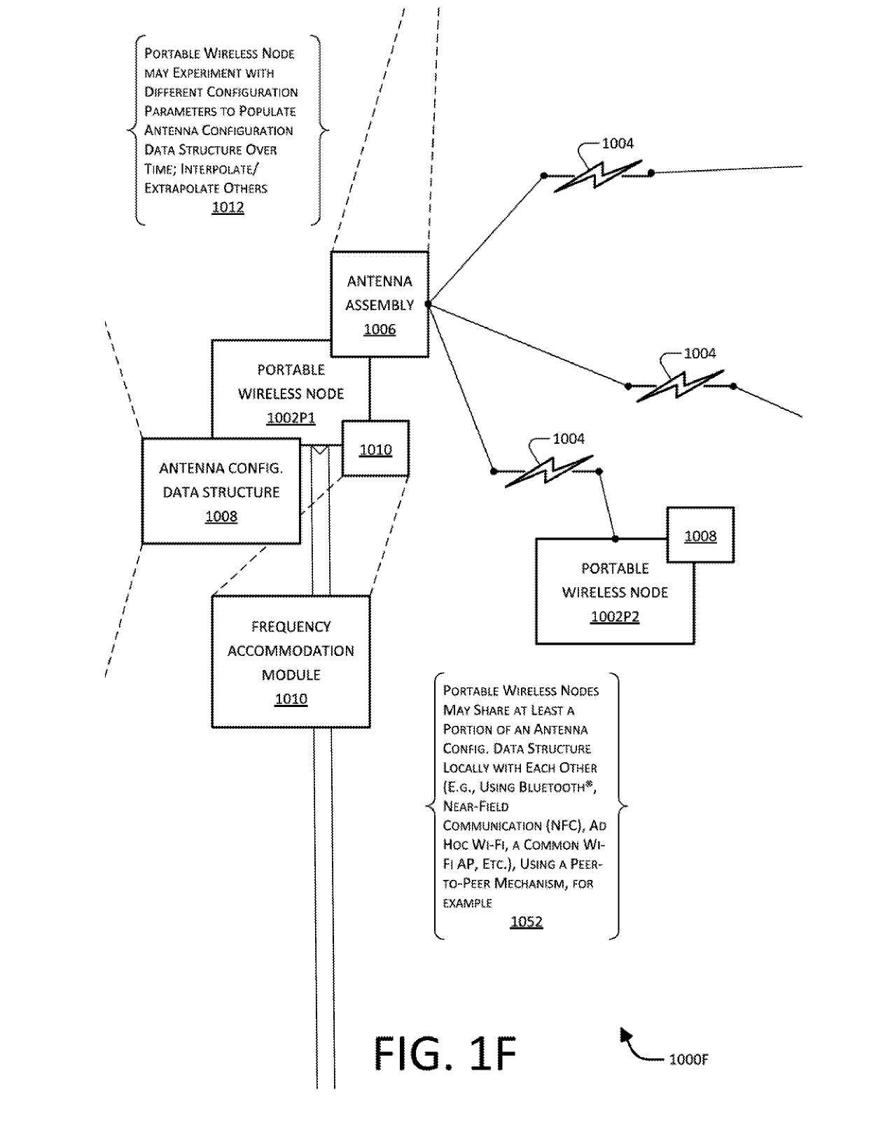

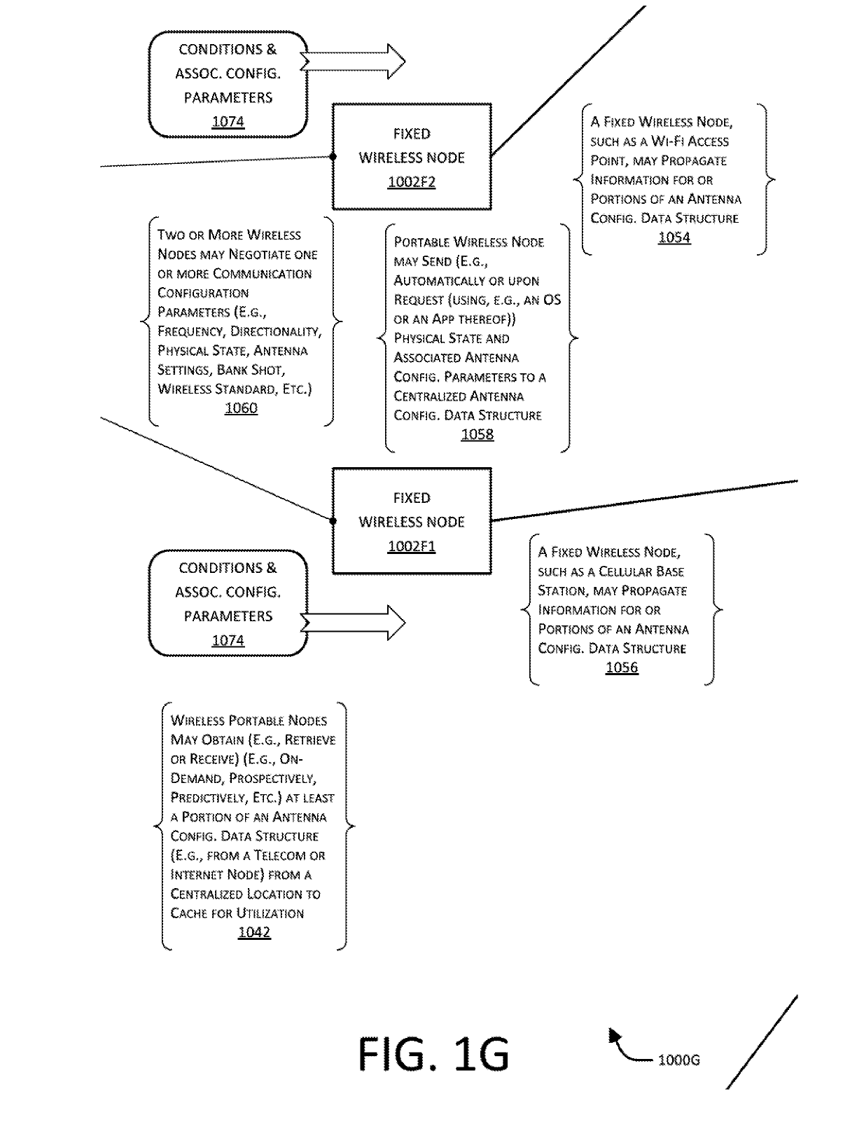

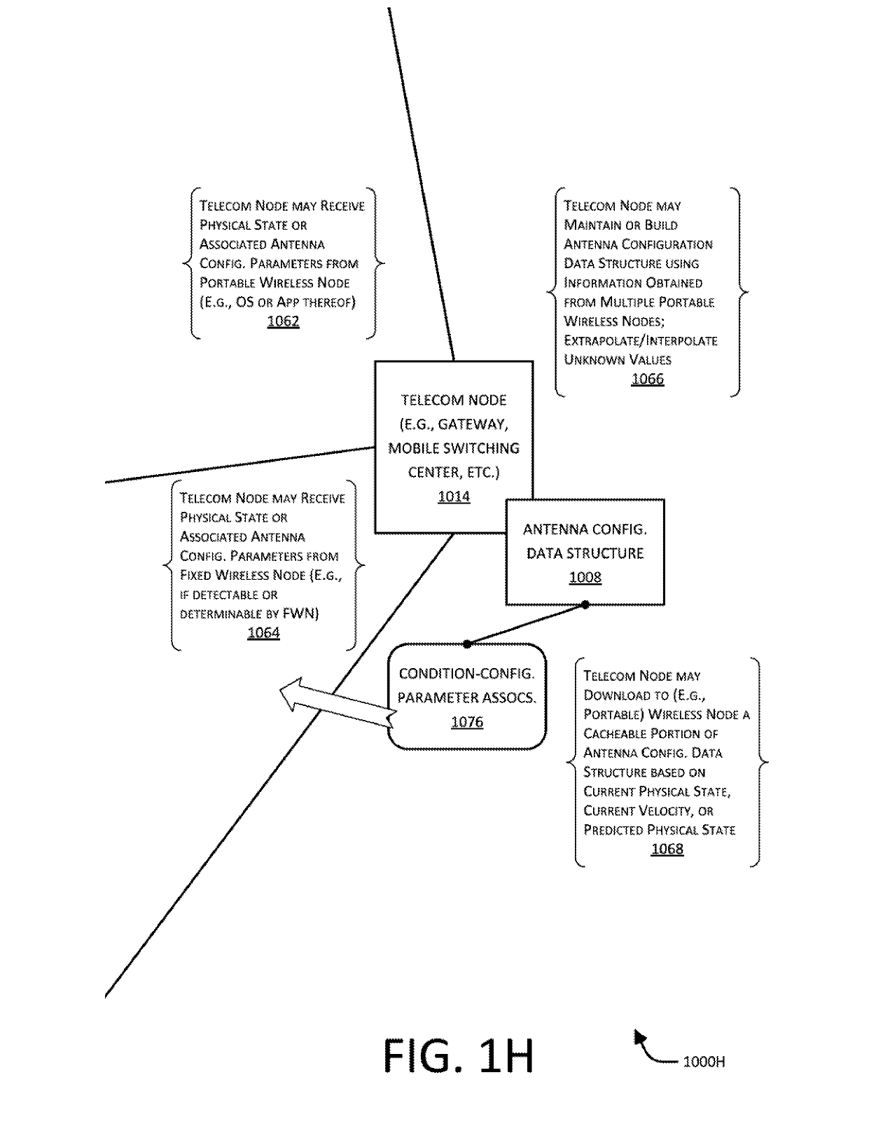

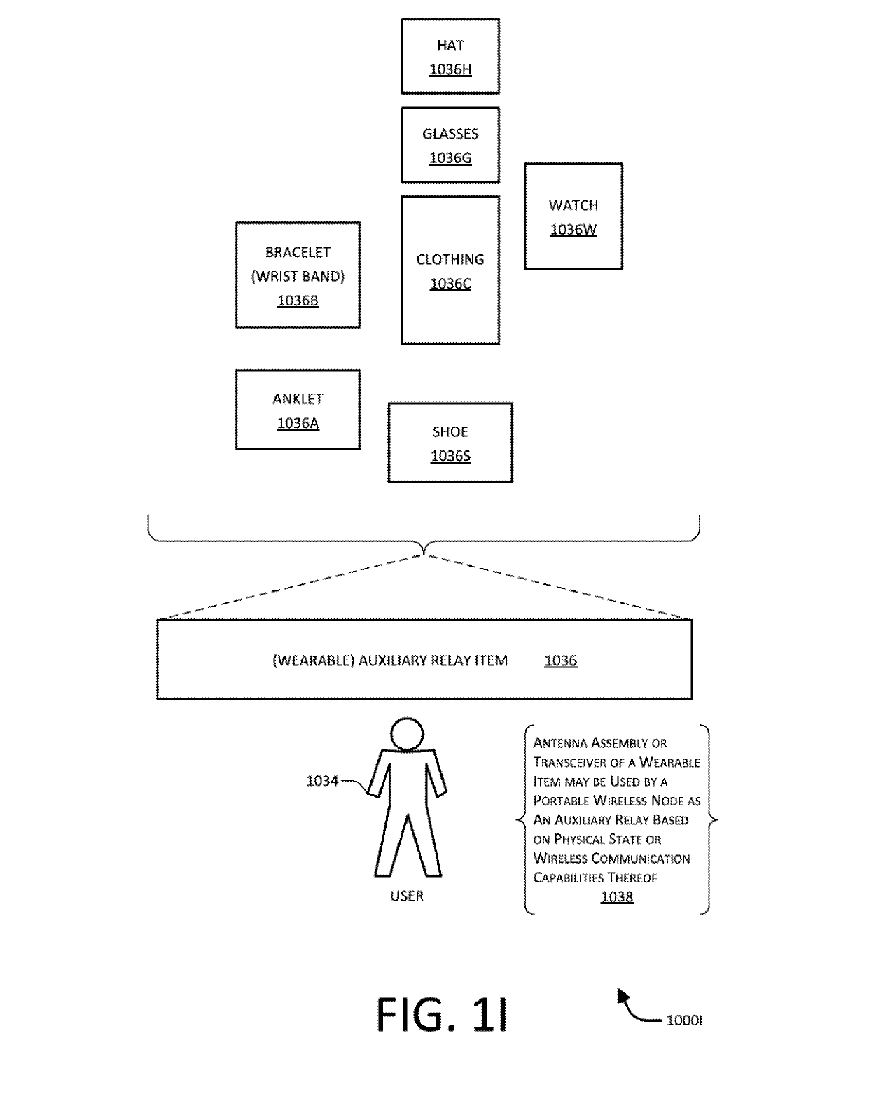

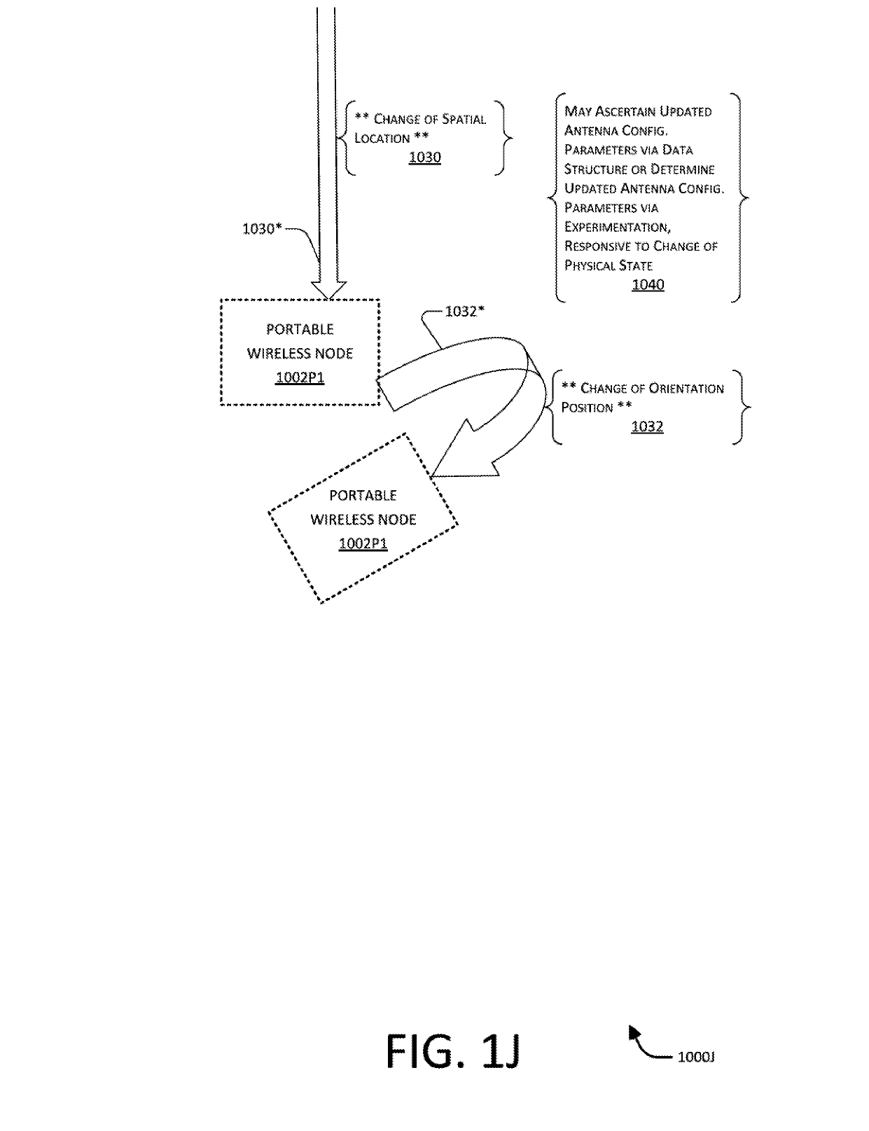

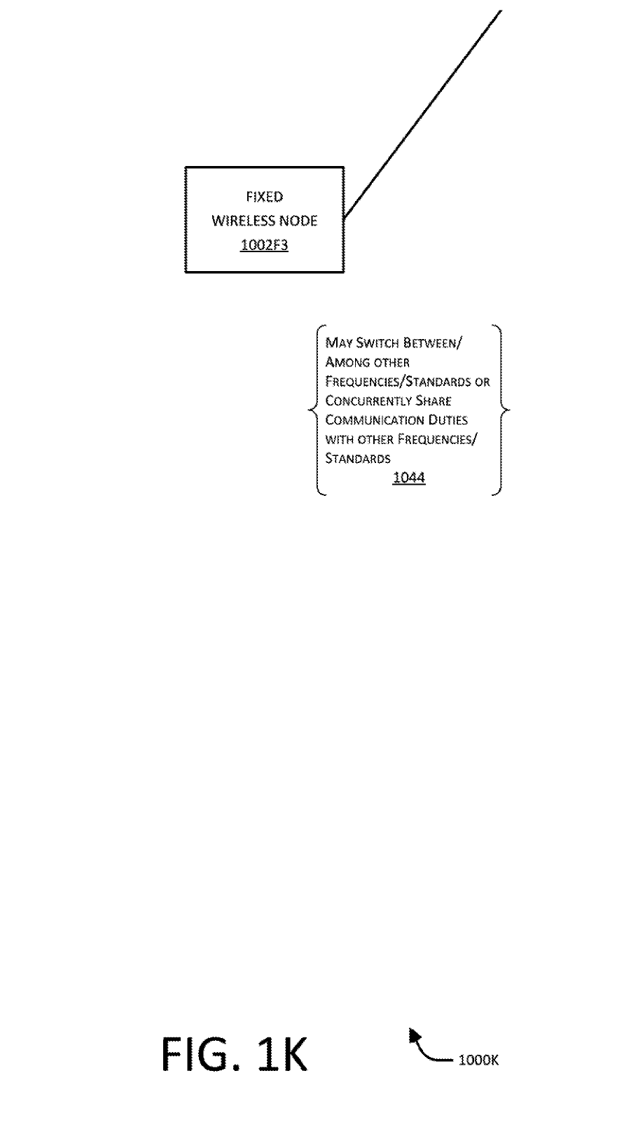

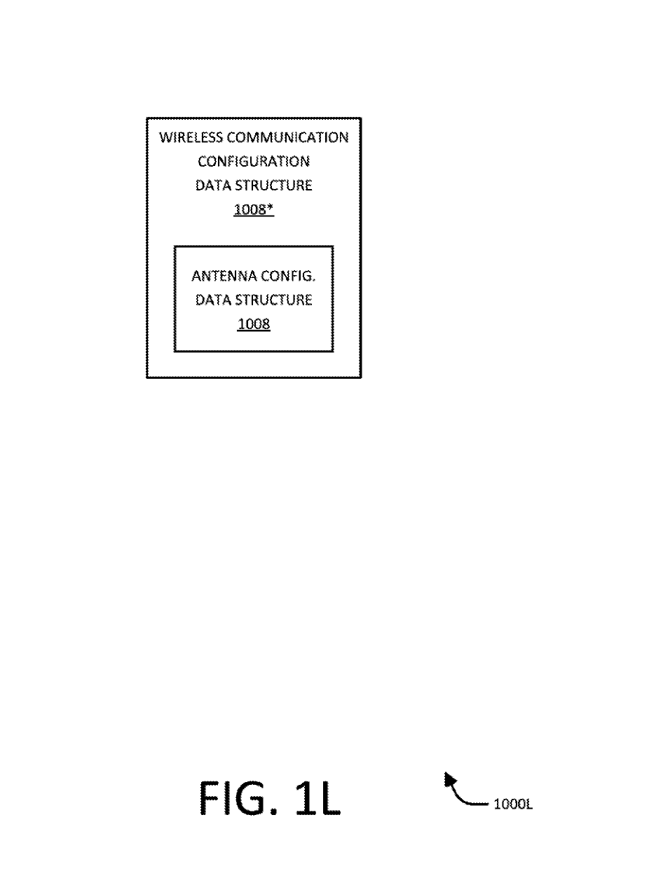

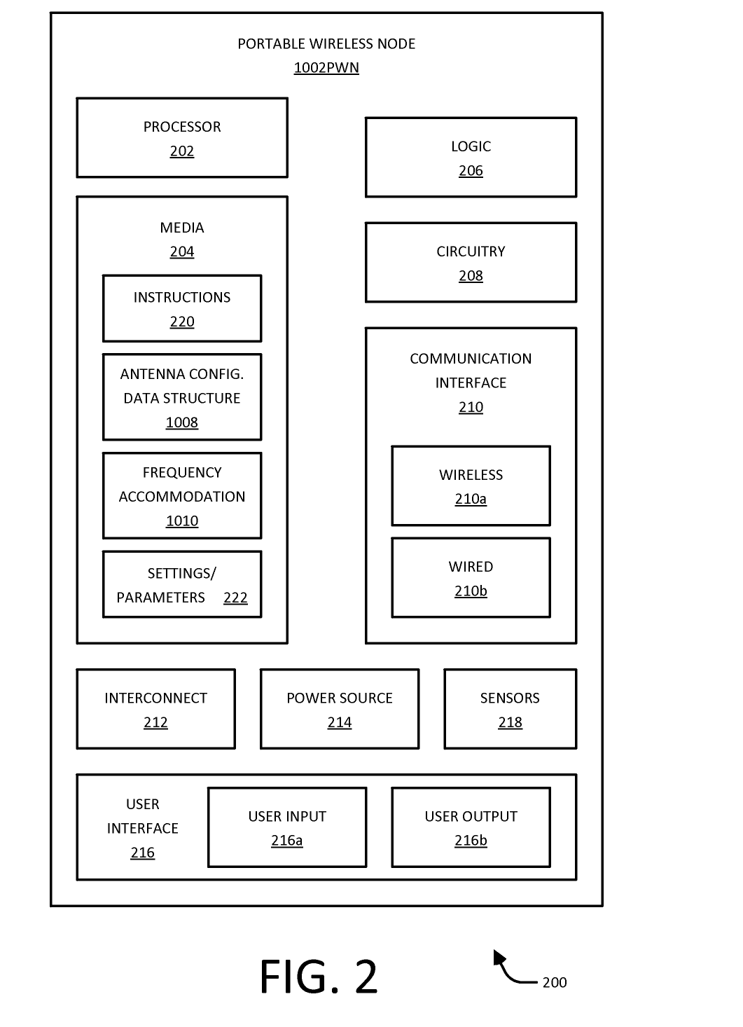

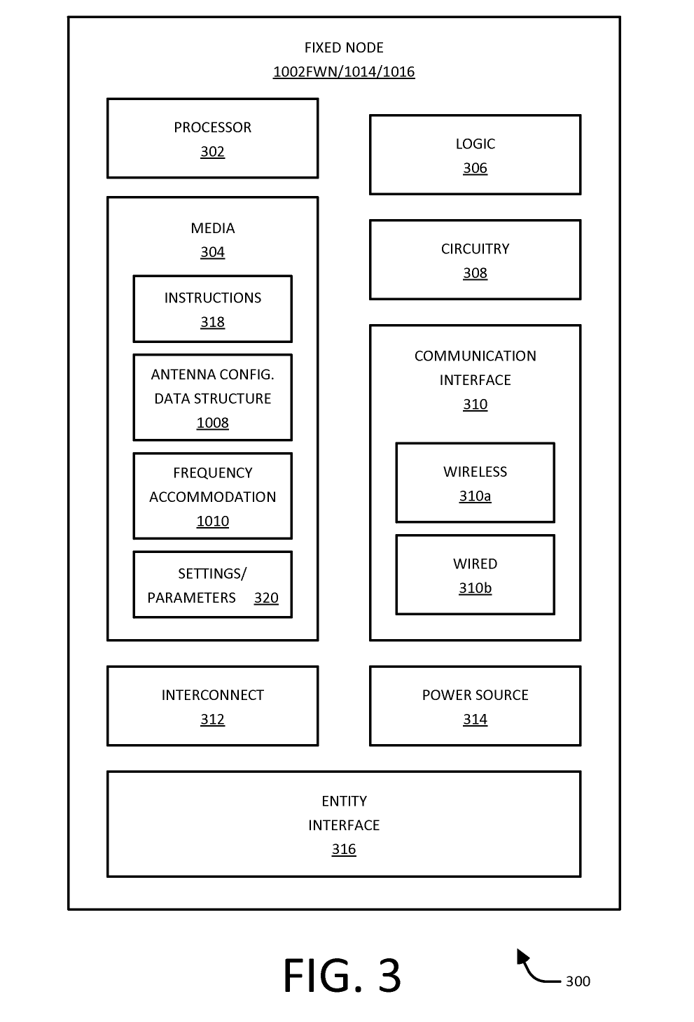

APPLICANT HEREBY INCORPORATES BY REFERENCE HEREIN DESCRIPTION OF AND TEXT ASSOCIATED WITH FIGS. 1-3 (E.G., FIGS. 1, 1A, 1B, 1C, 1D, 1E, 1F, 1G, 1H, 1I, 1J, 1K, 1L, 2, AND 3), INCLUDING BUT NOT LIMITED TO PARAGRAPHS [0017]-[0092] INCLUSIVE IN THEIR ENTIRETY, AT LEAST TO THE EXTENT SUCH SUBJECT MATTER IS NOT INCONSISTENT HEREWITH, OF U.S. patent application Ser. No. 13/842,040, entitled “Frequency Accommodation”, naming Roderick A. Hyde et al. as inventors, filed 15 Mar. 2013 (with Atty. Docket No. SE1-0855-US).

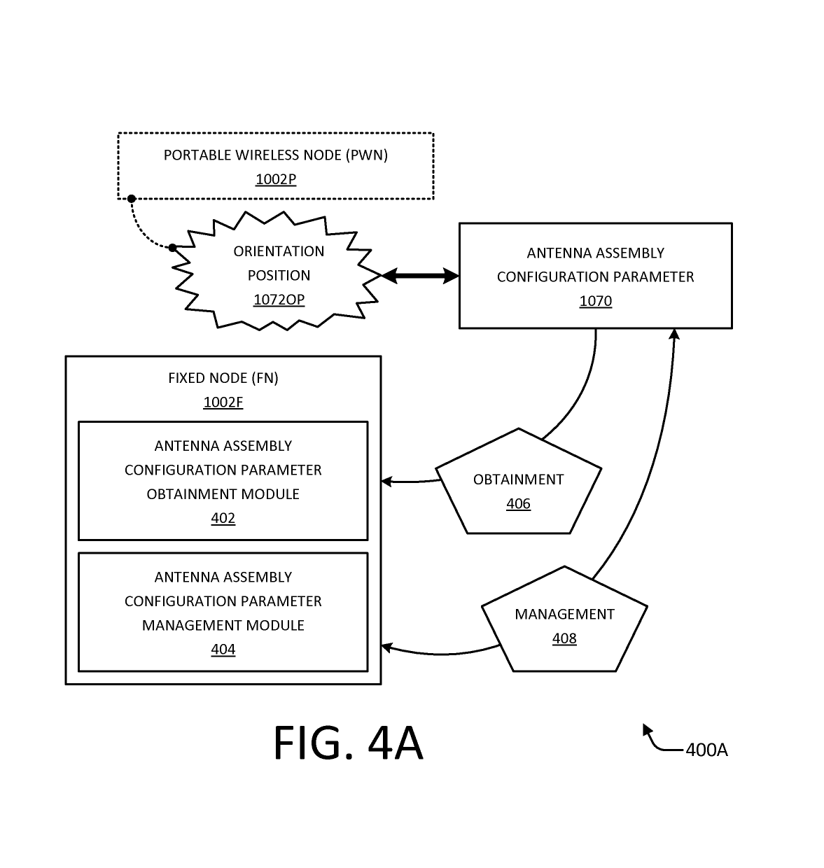

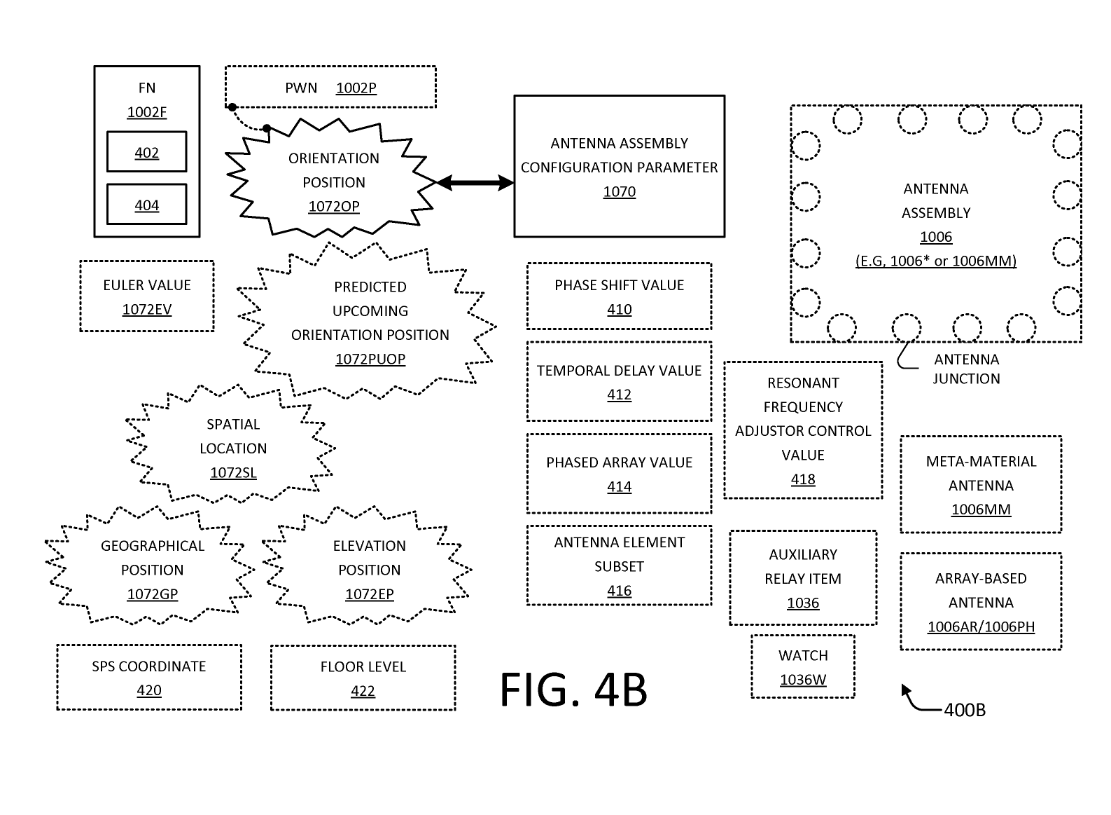

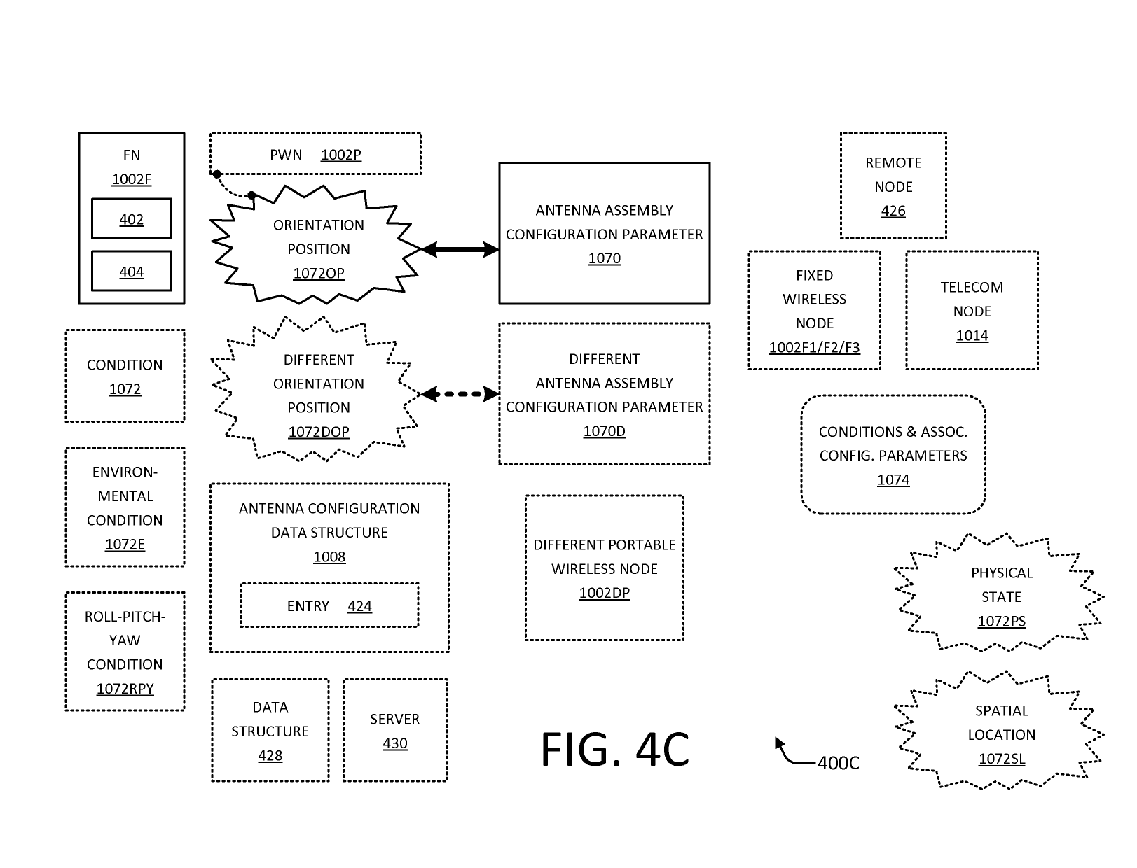

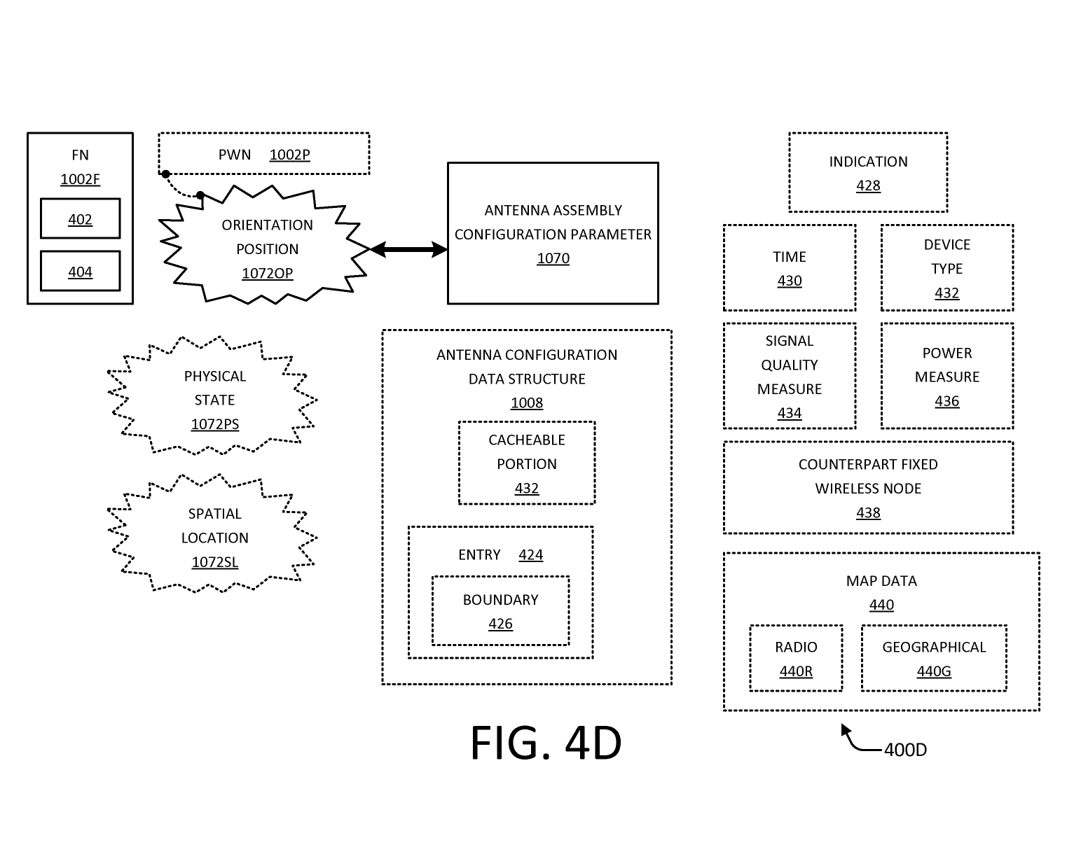

FIG. 4A is a schematic diagram 400A that includes at least one example device, such as a fixed node, that is capable of handling scenarios for facilitating wireless communication in conjunction with orientation position in accordance with certain example embodiments. As shown in FIG. 4A, by way of example but not limitation, schematic diagram 400A depicts at least one device that may include at least one antenna assembly configuration parameter obtainment module 402 or at least one antenna assembly configuration parameter management module 404. Additionally or alternatively, schematic diagram 400A may include, by way of example but not limitation, at least one obtainment 406, at least one management 408, at least one antenna assembly configuration parameter 1070, at least one orientation position 1072OP, or at least one portable wireless node (PWN) 1002P. More specifically, schematic diagram 400A may include a device that includes or comprises at least one fixed node (FN) 1002F. By way of example but not limitation, an antenna assembly configuration parameter obtainment module 402 or an antenna assembly configuration parameter management module 404 may include or comprise or be realized with at least one processor that executes instructions (e.g., sequentially, in parallel, at least partially overlapping in a time-multiplexed fashion, at least partially across multiple cores, or a combination thereof, etc.) as at least one special-purpose computing component, or otherwise as described herein. However, claimed subject matter is not limited to any particular described embodiments, implementations, examples, etc.

For certain example embodiments, an antenna assembly configuration parameter obtainment module 402 or an antenna assembly configuration parameter management module 404 may be implemented separately or at least partially jointly or in combination. For certain example implementations, an antenna assembly configuration parameter obtainment module 402 may be configured to obtain one or more antenna assembly configuration parameters that are associated with at least one orientation position of at least one portable wireless node. For certain example implementations, an antenna assembly configuration parameter management module 404 may be configured to manage one or more antenna assembly configuration parameters that are associated with at least one orientation position of at least one portable wireless node.

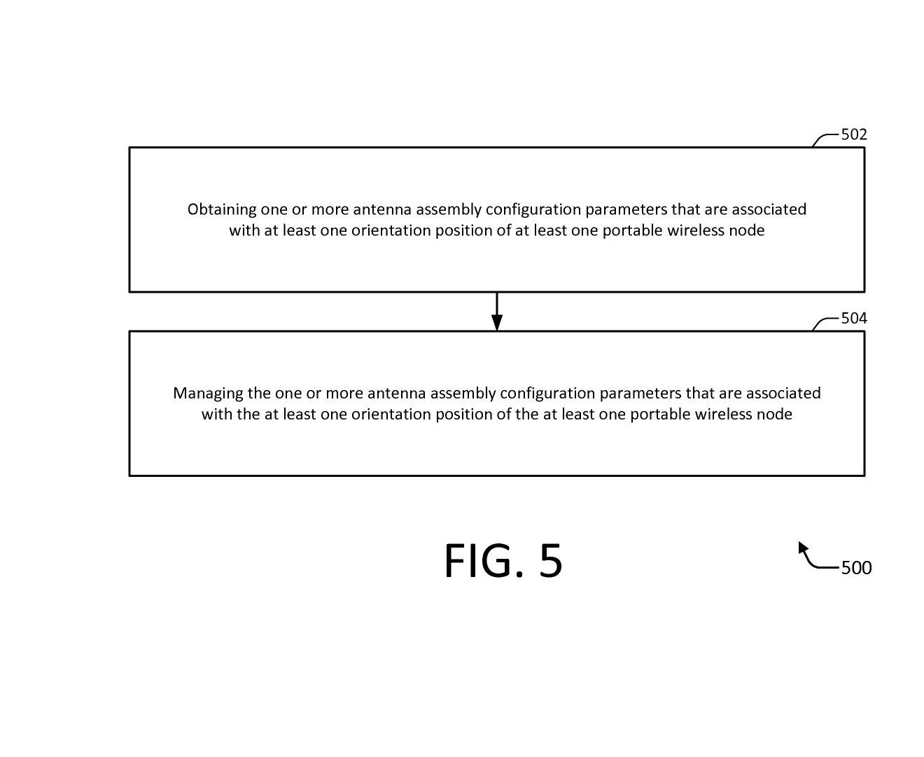

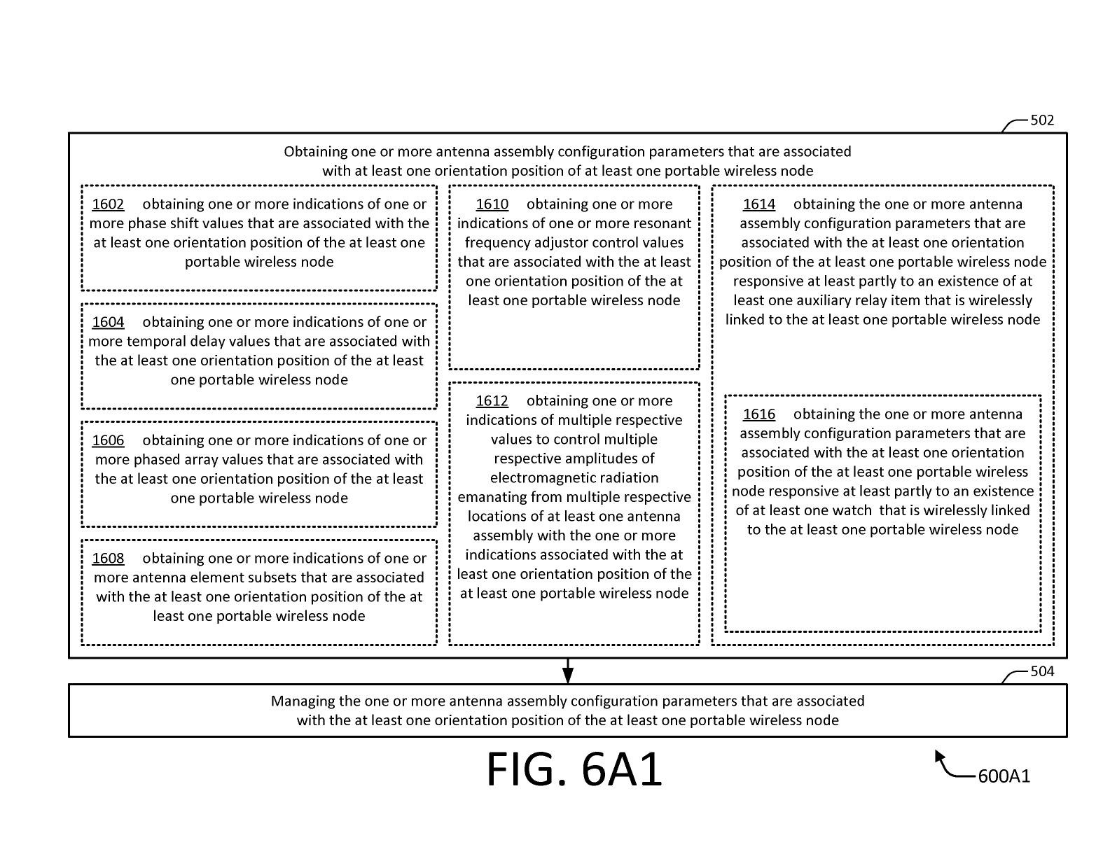

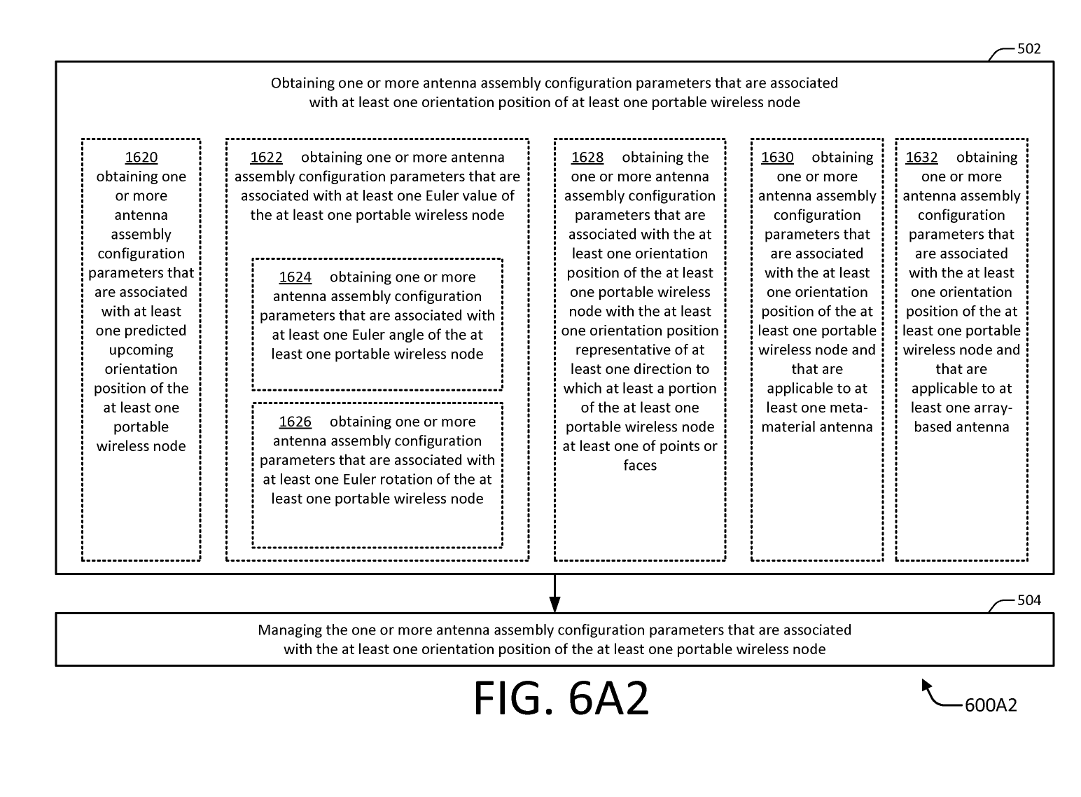

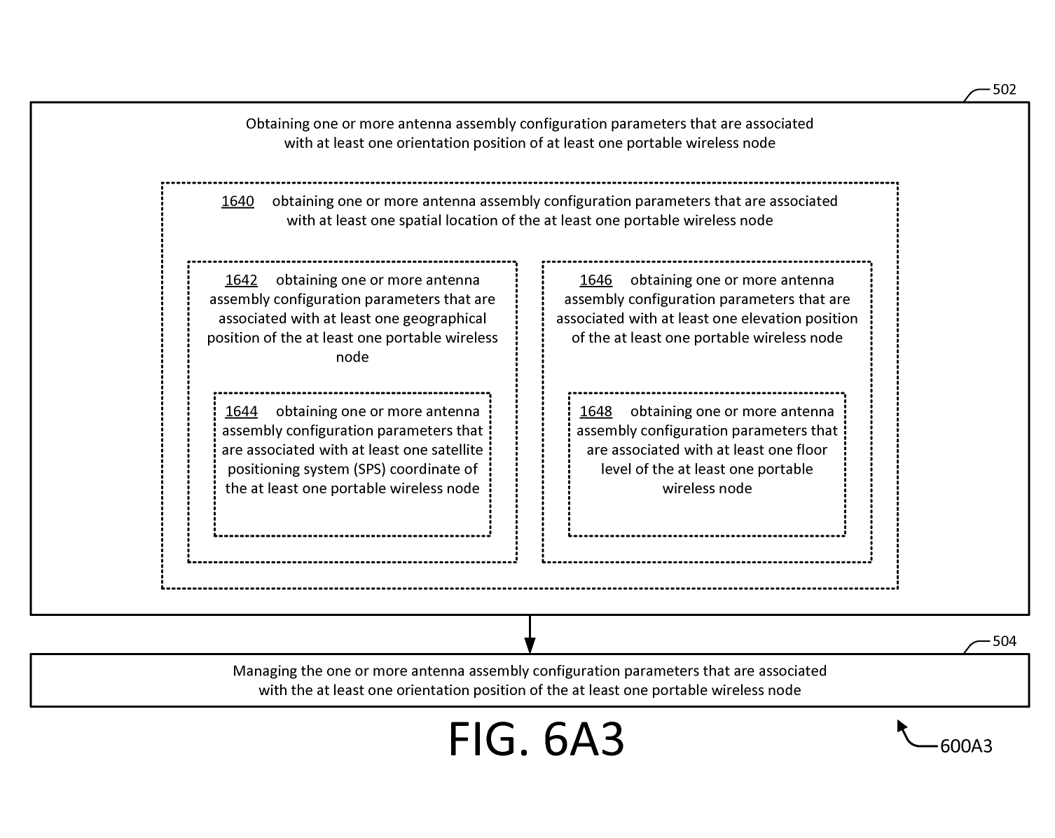

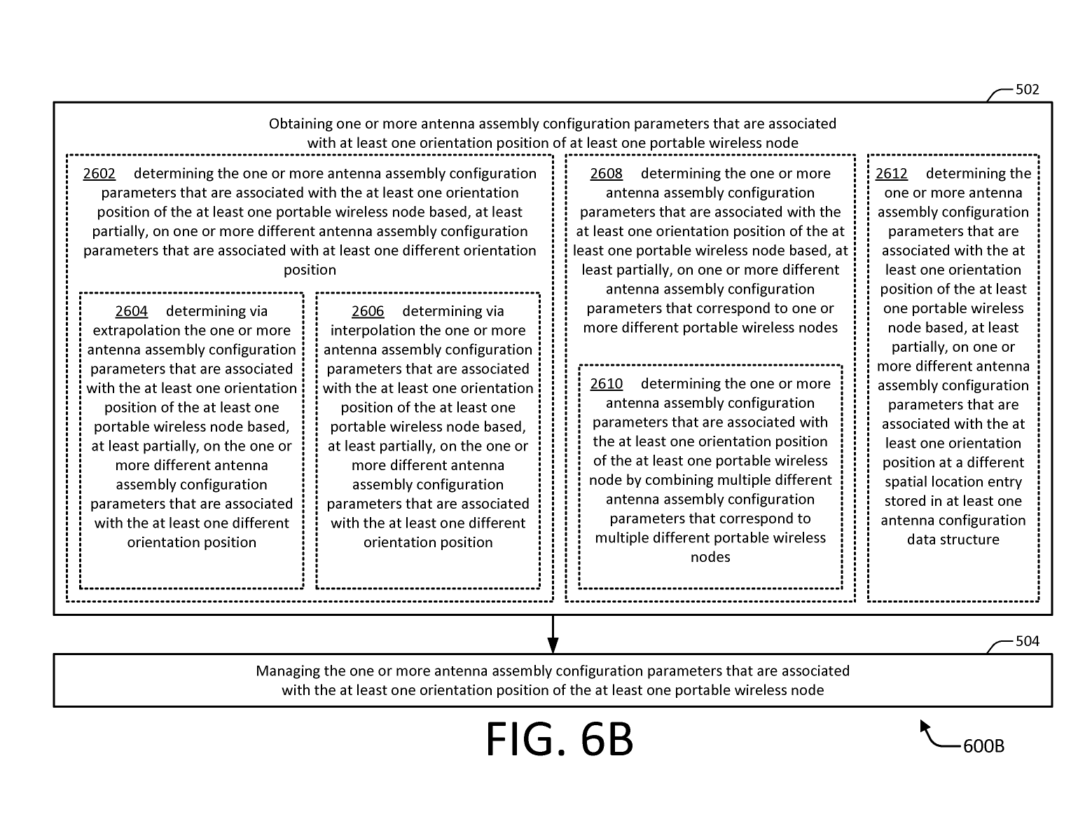

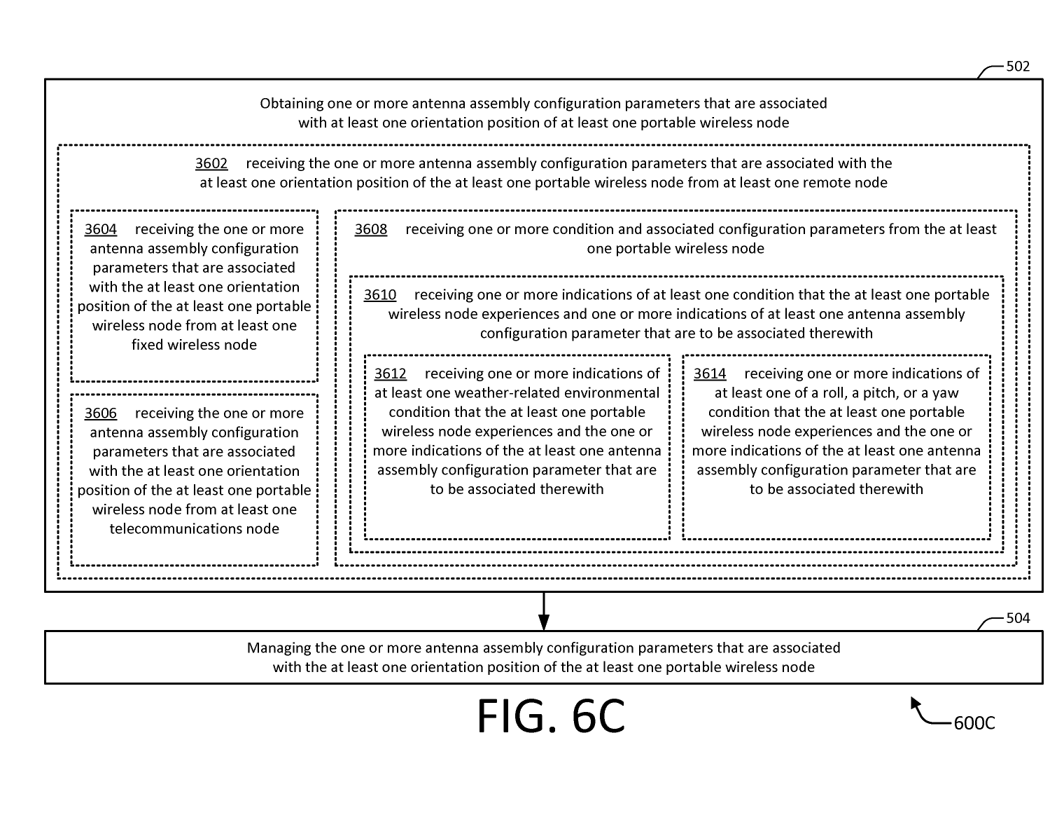

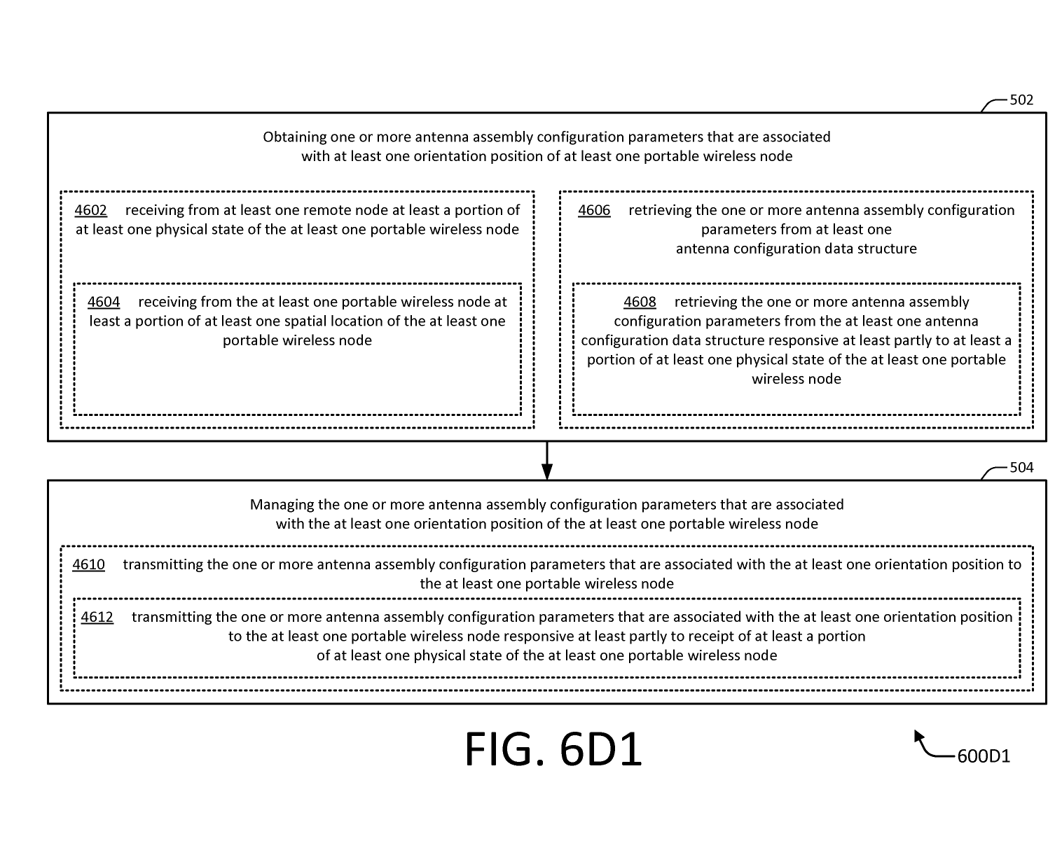

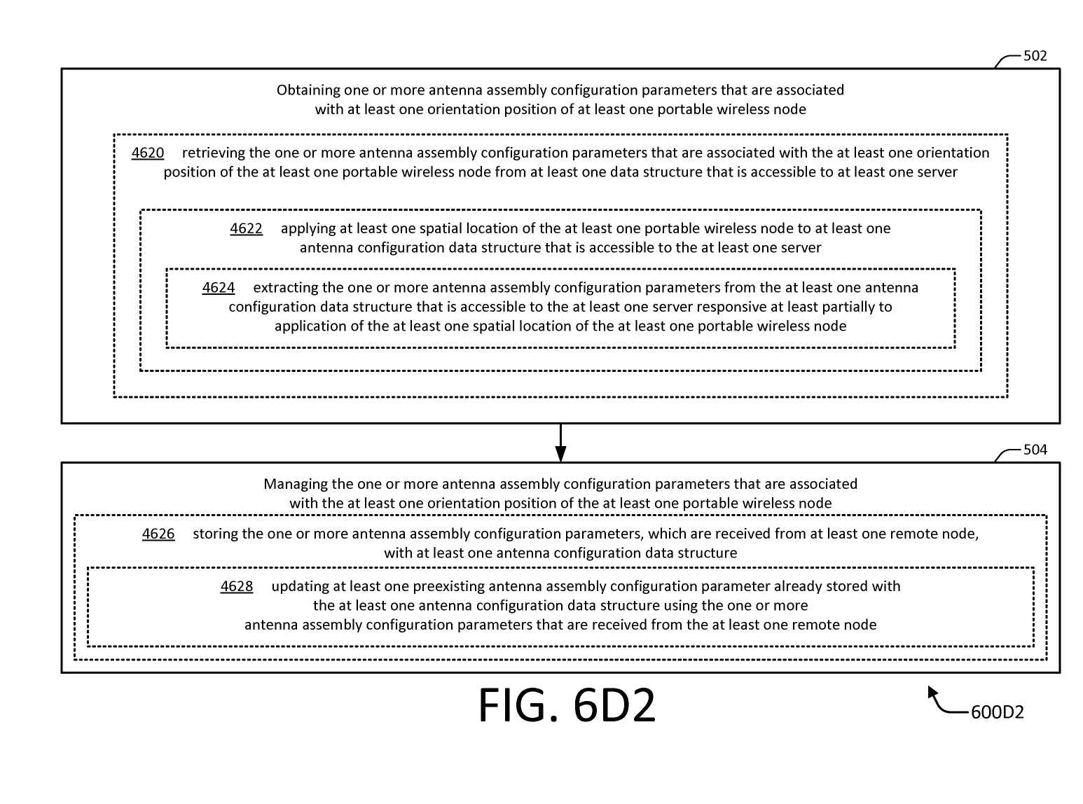

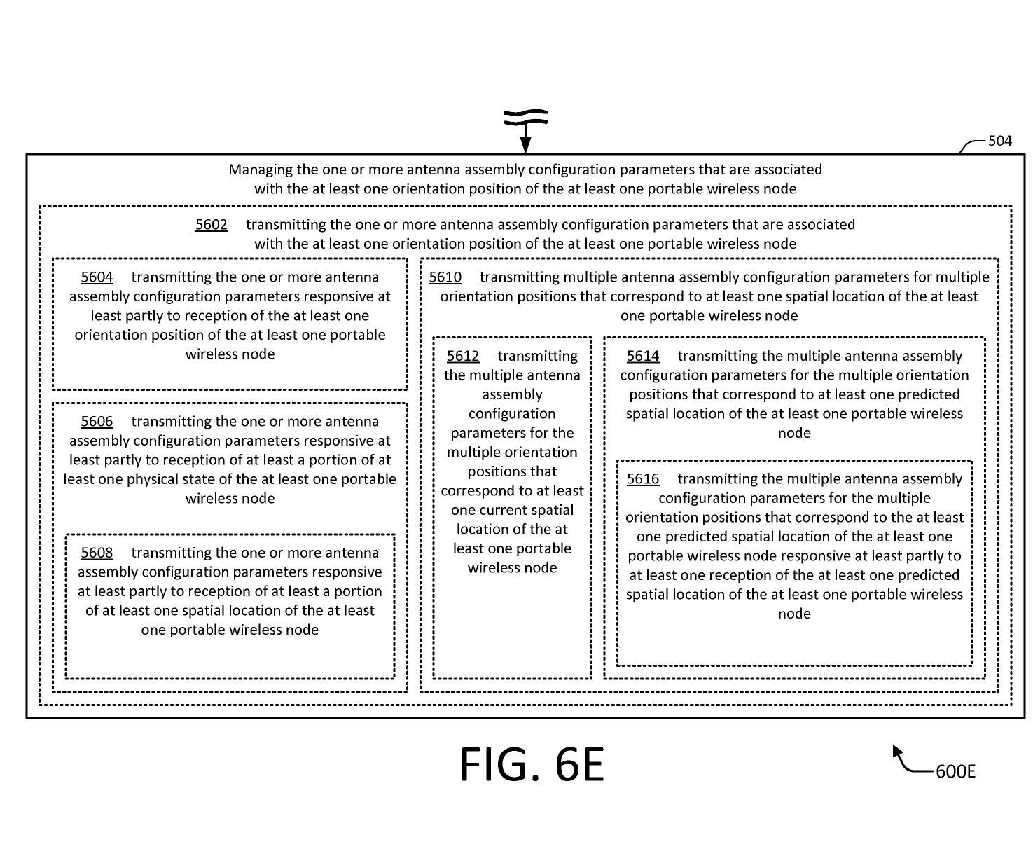

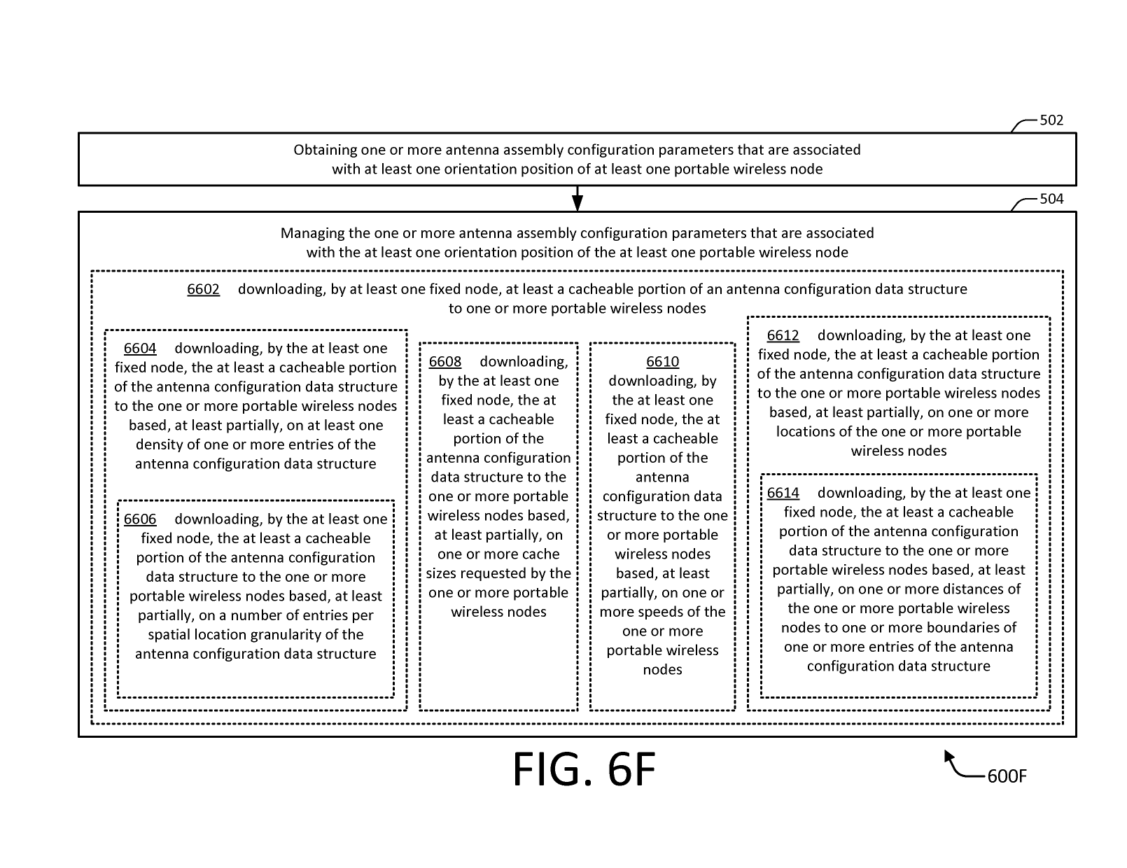

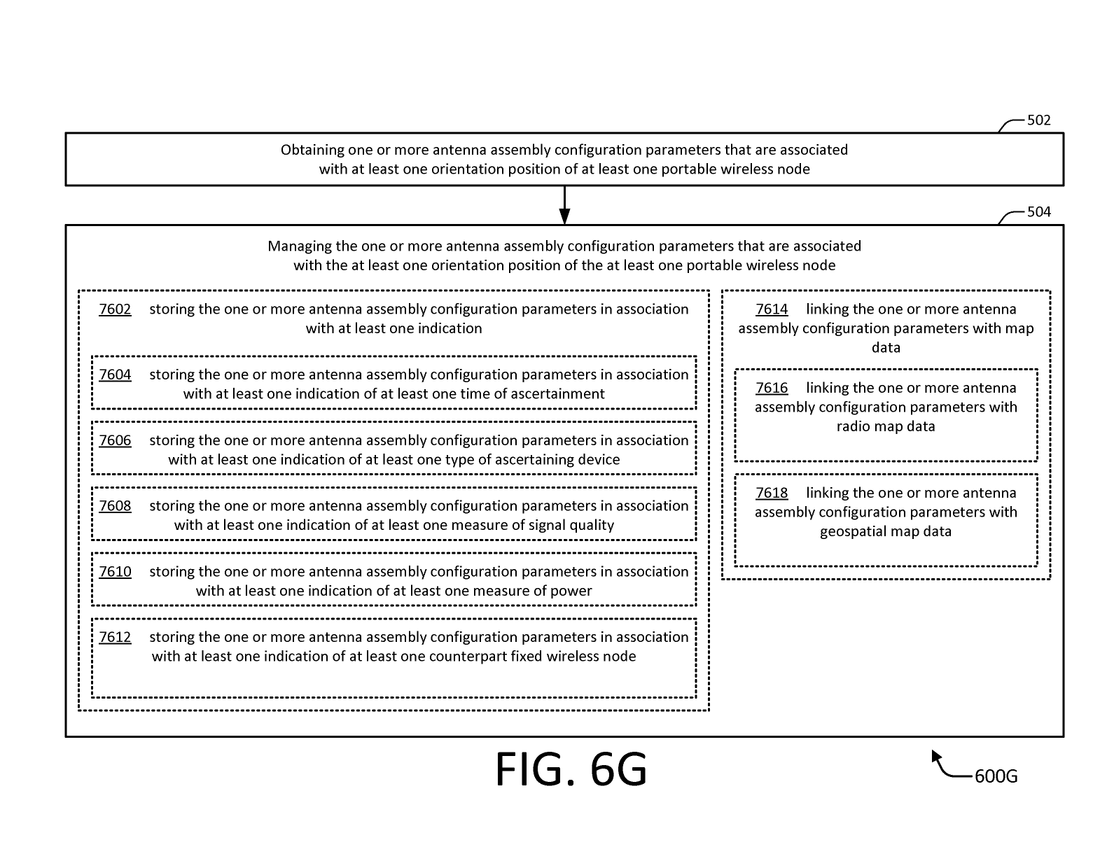

FIGS. 4B-4D are schematic diagrams 400B-400D that include at least one example device and that depict example scenarios for facilitating wireless communication in conjunction with orientation position in accordance with certain example embodiments. As shown in FIGS. 4B-4D, by way of example but not limitation, one or more of schematic diagrams 400B-400D may include at least one fixed node (FN) 1002F, at least one antenna assembly configuration parameter obtainment module 402, at least one antenna assembly configuration parameter management module 404, at least one antenna assembly configuration parameter 1070, at least one orientation position 1072OP, or at least one portable wireless node (PWN) 1002P. Each of schematic diagrams 400B-400D may include alternative or additional depictions, which may relate to facilitating wireless communication in conjunction with orientation position, as described herein. In addition to or in alternative to description herein below with specific reference to FIGS. 4B-4D, illustrated aspects of schematic diagrams 400B-400D may be relevant to example description with reference to any one or more of FIG. 5 or 6A1-6G. However, claimed subject matter is not limited to any particular described embodiments, implementations, examples, etc.

As shown in FIG. 4B, by way of example but not limitation, schematic diagram 400B may further include at least one phase shift value 410, at least one temporal delay value 412, at least one phased array value 414, at least one antenna element subset 416, at least one resonant frequency adjustor control value 418, at least one antenna assembly 1006, at least one auxiliary relay item 1036, at least one watch 1036W, at least one predicted upcoming orientation position 1072PU0P, at least one Euler value 1072EV, at least one meta-material antenna 1006MM, at least one array-based antenna 1006AR/1006PH/1006*, at least one spatial location 10725L, at least one geographical position 1072GP, at least one satellite positioning system (SPS) coordinate 420, at least one elevation position 1072EP, or at least one floor level 422. Additional or alternative description that may be relevant to schematic diagram 400B is provided herein below with particular reference to one or more of any of FIGS. 6A1-6G.

As shown in FIG. 4C, by way of example but not limitation, schematic diagram 400C may further include at least one different antenna assembly configuration parameter 1070D, at least one different orientation position 1072DOP, at least one different portable wireless node 1002DP, at least one antenna configuration data structure 1008, at least one entry 424, at least one remote node 426, at least one fixed wireless node 1002F1/F2/F3, at least one telecommunications node 1014, at least one condition and associated configuration parameter 1074, at least one condition 1072, at least one weather-related environmental condition 1072E, at least one of a roll or a pitch or a yaw condition 1072RPY, at least one physical state 1072PS, at least one spatial location 10725L, at least one data structure 428, or at least one server 430. Additional or alternative description that may be relevant to schematic diagram 400C is provided herein below with particular reference to one or more of any of FIGS. 6A1-6G.

As shown in FIG. 4D, by way of example but not limitation, schematic diagram 400D may further include at least one physical state 1072PS, at least one spatial location 10725L, at least one cacheable portion 432, at least one antenna configuration data structure 1008, at least one entry 424, at least one boundary 426, at least one indication 428, at least one time of ascertainment 430, at least one type of ascertaining device 432, at least one measure of signal quality 434, at least one measure of power 436, at least one counterpart fixed wireless node 438, at least some map data 440, at least some radio map data 440R, or at least some geographical map data 440G. Additional or alternative description that may be relevant to schematic diagram 400D is provided herein below with particular reference to one or more of any of FIGS. 6A1-6G.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 5 is a flow diagram 500 illustrating an example method for at least one device with regard to facilitating wireless communication in conjunction with orientation position in accordance with certain example embodiments. As illustrated, flow diagram 500 may include any of operations 502-504. Although operations 502-504 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 500 may be performed so as to be fully or partially overlapping with other operation(s). For certain example embodiments, one or more operations of flow diagram 500 may be performed by at least one device, such as a fixed node 1002F or at least a portion thereof. However, claimed subject matter is not limited to any particular described embodiments, implementations, examples, etc.

For certain example embodiments, a method for facilitating wireless communication in conjunction with orientation position (e.g., that may include, involve, address, react to, pertain to, or a combination thereof, etc. or other otherwise relate to frequency accommodation), which method may be at least partially implemented using hardware (e.g., circuitry, at least one processor, processor-accessible memory, at least one module, or a combination thereof, etc.) of a device such as a fixed node, may include an operation 502 or an operation 504. An operation 502 may be directed at least partially to obtaining one or more antenna assembly configuration parameters that are associated with at least one orientation position of at least one portable wireless node. For certain example implementations, at least one device (e.g., a fixed node 1002F, such as at least one fixed wireless node 1002F1/F2/F3, at least one telecommunications node 1014, at least one internet node 1016, or a combination thereof, etc.) may obtain (e.g., acquire, ascertain, determine, receive, retrieve, procure, or a combination thereof, etc. via at least one obtainment 406) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, or a combination thereof, etc.) that are associated with (e.g., that correspond to, that are linked to, that relate to, that pertain to, that are matched with, that are mated to, that are derived from, or a combination thereof, etc.) at least one orientation position 1072OP (e.g., a direction that is being faced toward or pointed to, a vector in space, an Euler value, a roll or pitch or yaw value, a rotational position, or a combination thereof, etc.) of at least one portable wireless node 1002P (e.g., a mobile device, a mobile phone, a tablet, a slate computer, a phablet, a portable gaming device, a smartphone, a notebook computer, a mobile repeater, a UE, a MS, a laptop computer, a hand-held radio, a walker-talkie, a roving transceiver, a wireless device that moves under its own power (e.g., a motorized robot or an unmanned aerial vehicle (UAV)), a wireless device that moves under the power of another entity (e.g., a human or a machine such as a vehicle), or a combination thereof, etc.). By way of example but not limitation, at least one fixed node may obtain one or more antenna assembly configuration parameters that are associated with at least one orientation position of at least one portable wireless node (e.g., a fixed node, such as a cloud server device, may acquire one or more antenna-related settings that are associated with at least one angular position in space of a portable wireless node).

For certain example embodiments, an operation 504 may be directed at least partially to managing the one or more antenna assembly configuration parameters that are associated with the at least one orientation position of the at least one portable wireless node. For certain example implementations, at least one device (e.g., a fixed node 1002F, such as at least one fixed wireless node 1002F1/F2/F3, at least one telecommunications node 1014, at least one internet node 1016, or a combination thereof, etc.) may manage (e.g., manipulate, disseminate, organize, store, apply, share, implement, handle, administer, or a combination thereof, etc. via at least one management 408) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields interact with an adjustable antenna assembly, at least one manipulation of signals being forwarded to or accepted from an antenna assembly, or a combination thereof, etc.) that are associated with (e.g., that correspond to, that are linked to, that relate to, that pertain to, that are matched with, that are mated to, that are derived from, or a combination thereof, etc.) at least one orientation position 1072OP (e.g., a direction that is being faced toward or pointed to, a vector in space, an Euler value, a roll or pitch or yaw value, a rotational position, or a combination thereof, etc.) of at least one portable wireless node 1002P (e.g., a mobile device, a mobile phone, a tablet, a slate computer, a phablet, a portable gaming device, a smartphone, a notebook computer, a mobile repeater, a UE, a MS, a laptop computer, a hand-held radio, a walker-talkie, a roving transceiver, or a combination thereof, etc.). By way of example but not limitation, at least one fixed node may manage the one or more antenna assembly configuration parameters that are associated with the at least one orientation position of the at least one portable wireless node (e.g., a telecommunications node (i) may store into memory or (ii) may transmit to a portable wireless node via at least one fixed wireless node one or more antenna-related settings that are associated with at least one current or predicted angular position in space of the portable wireless node).

FIGS. 6A1-6G (e.g., 6A1, 6A2, 6A3, 6B, 6C, 6D1, 6D2, 6E, 6F, and 6G) depict example additions or alternatives for a flow diagram of FIG. 5 in accordance with certain example embodiments. As illustrated, flow diagrams of FIGS. 6A1-6G may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently or along with one or more other operations). Also, at least some operation(s) of flow diagrams of FIGS. 6A1-6G may be performed so as to be fully or partially overlapping with other operation(s). For certain example embodiments, one or more operations of flow diagrams 600A1-600G (of FIGS. 6A1-6G) may be performed by at least one device (e.g., a fixed node 1002F or at least a portion thereof). However, claimed subject matter is not limited to any particular described embodiments, implementations, examples, etc.

FIG. 6A1 illustrates a flow diagram 600A1 having any one or more of example operations 1602-1616. For example, an operation 502 may include an operation 1602 of obtaining one or more indications of one or more phase shift values that are associated with the at least one orientation position of the at least one portable wireless node. For instance, at least one fixed node 1002F (e.g., a telecom node 1014, an internet node 1016, or a combination thereof, etc.) may obtain (e.g., acquire) one or more indications (e.g., identification) of one or more phase shift values 410 (e.g., a number or numerical range, a setting implementing a phase shift, one or more switches or processing to realize a phase shift, a phase delay value, an identification of how or how much to change a phase or a timing of a signal, a selection or length of a signal phase delay line, or a combination thereof, etc.) that are associated with at least one orientation position 1072OP (e.g., a 45 degree angle tilt) of at least one portable wireless node 1002P (e.g., a mobile phone).

For example, an operation 502 may include an operation 1604 of obtaining one or more indications of one or more temporal delay values that are associated with the at least one orientation position of the at least one portable wireless node. For instance, at least one fixed node 1002F (e.g., a telecom node 1014, an internet node 1016, or a combination thereof, etc.) may obtain (e.g., receive from another node) one or more indications (e.g., a listing) of one or more temporal delay values 412 (e.g., a number or numerical range, a setting implementing a temporal delay, one or more switches or processing to realize a temporal delay, a time shifting value, an identification of how or how much to change a timing or a phase of a signal, a selection or length of a signal timing delay line, or a combination thereof, etc.) that are associated with at least one orientation position 1072OP (e.g., at least one number representing at least one Euler value) of at least one portable wireless node 1002P (e.g., a tablet computer).

For example, an operation 502 may include an operation 1606 of obtaining one or more indications of one or more phased array values that are associated with the at least one orientation position of the at least one portable wireless node. For instance, at least one fixed node 1002F (e.g., a telecom node 1014, an internet node 1016, or a combination thereof, etc.) may obtain (e.g., retrieve from memory) one or more indications (e.g., description) of one or more phased array values 414 (e.g., a number or numerical range, a setting implementing directionality or beamforming, one or more switches or processing to realize a directed or beamformed signal, an explanation of how or how much to change a direction or a shape of a signal wave or beam, an identification of which antenna patch or antenna patches to employ, a matrix of values to program operation of an array-based antenna, or a combination thereof, etc.) that are associated with at least one orientation position 1072OP (e.g., a cardinal direction such as West to which a screen is facing) of at least one portable wireless node 1002P (e.g., a Nokia Lumia phone).

For example, an operation 502 may include an operation 1608 of obtaining one or more indications of one or more antenna element subsets that are associated with the at least one orientation position of the at least one portable wireless node. For instance, at least one fixed node 1002F (e.g., a telecom node 1014, an internet node 1016, or a combination thereof, etc.) may obtain (e.g., ascertain via at least one calculation) one or more indications (e.g., look-up values) of one or more antenna element subsets 416 (e.g., a listing or group of antenna elements, a listing or group of antenna junctions coupled to antenna elements, a subset of—or less than all of—an available set of antenna elements, a matrix or process coupling less than all available antenna elements to a receive or transmit chain, or a combination thereof, etc.) that are associated with at least one orientation position 1072OP (e.g., 30 degrees from vertical and 45 degrees from extending North-to-South) of at least one portable wireless node 1002P (e.g., a smart phone).

For example, an operation 502 may include an operation 1610 of obtaining one or more indications of one or more resonant frequency adjustor control values that are associated with the at least one orientation position of the at least one portable wireless node. For instance, at least one fixed node 1002F (e.g., a telecom node 1014, an internet node 1016, or a combination thereof, etc.) may obtain (e.g., receive via an internet connection) one or more indications (e.g., a code or explanation) of one or more resonant frequency adjustor control values 418 (e.g., a number or numerical range, a current, a voltage level, a representation of control input to set a resonant frequency of at least one position on a surface scattering antenna, a matrix or process to establish one or more resonant frequencies of a meta-material antenna, or a combination thereof, etc.) that are associated with at least one orientation position 1072OP (e.g., a pitch or yaw value) of at least one portable wireless node 1002P (e.g., an Apple iPad).

For example, an operation 502 may include an operation 1612 of obtaining one or more indications of multiple respective values to control multiple respective amplitudes of electromagnetic radiation emanating from multiple respective locations of at least one antenna assembly with the one or more indications associated with the at least one orientation position of the at least one portable wireless node. For instance, at least one fixed node 1002F (e.g., a telecom node 1014, an internet node 1016, or a combination thereof, etc.) may obtain (e.g., calculate) one or more indications of (e.g., signifier of or reference to) multiple respective values (e.g., numeral or variable name or table entry) to control multiple respective amplitudes (e.g., magnitude) of electromagnetic radiation (e.g., radio frequency waves) emanating (e.g., transmitting) from multiple respective locations (e.g., position or coordinate) of at least one antenna assembly 1006 (e.g., at least one antenna with one or more radiating elements, at least one meta-material antenna 1006MM, at least one array-based antenna 1006*, or a combination thereof, etc.) with the one or more indications associated with at least one orientation position 1072OP (e.g., lying flat parallel to the earth with a “top” end pointing between 15 and 35 degrees east of north) of at least one portable wireless node 1002P (e.g., a tablet computer).

For example, an operation 502 may include an operation 1614 of obtaining the one or more antenna assembly configuration parameters that are associated with the at least one orientation position of the at least one portable wireless node responsive at least partly to an existence of at least one auxiliary relay item that is wirelessly linked to the at least one portable wireless node. For instance, at least one fixed node 1002F (e.g., a telecom node 1014, an internet node 1016, or a combination thereof, etc.) may obtain (e.g., calculate based on data) one or more antenna assembly configuration parameters 1070 (e.g., a directionality range pointing toward a target) that are associated with at least one orientation position 1072OP (e.g., an angle defined relative to a top of a user's head) of at least one portable wireless node 1002P (e.g., an Android Nexus device) responsive at least partly to an existence (e.g., a presence, a proximity sufficient to enable wireless communication, a knowledge, an activated indicator, or a combination thereof, etc.) of at least one auxiliary relay item 1036 (e.g., a hat having a transponder, a bracelet, a coat having a transceiver, or a combination thereof, etc.) that is wirelessly linked (e.g., synchronized with, capable of wireless communication with, aware of one another, or a combination thereof, etc.) to the at least one portable wireless node 1002P.

For example, an operation 1614 may include an operation 1616 of obtaining the one or more antenna assembly configuration parameters that are associated with the at least one orientation position of the at least one portable wireless node responsive at least partly to an existence of at least one watch that is wirelessly linked to the at least one portable wireless node. For instance, at least one fixed node 1002F (e.g., a telecom node 1014, an internet node 1016, or a combination thereof, etc.) may obtain (e.g., receive from a device that determined via experimentation) one or more antenna assembly configuration parameters 1070 (e.g., an identified subset of antenna junctions of an antenna assembly) that are associated with at least one orientation position 1072OP (e.g., a description of a direction of a vector running from a bottom to a top) of at least one portable wireless node 1002P (e.g., an Apple iPhone) responsive at least partly to an existence (e.g., an accessibility, a compatibility, an activation or syncing, or a combination thereof, etc.) of at least one watch 1036W (e.g., an iWatch, a timepiece with wireless capabilities, a small clock adorning a wrist, or a combination thereof, etc.) that is wirelessly linked (e.g., synchronized with, capable of wireless communication with, aware of one another, or a combination thereof, etc) to the at least one portable wireless node 1002P.

FIG. 6A2 illustrates a flow diagram 600A2 having any one or more of example operations 1620-1632. For example, an operation 502 may include an operation 1620 of obtaining one or more antenna assembly configuration parameters that are associated with at least one predicted upcoming orientation position of the at least one portable wireless node. For instance, at least one fixed node 1002F (e.g., a telecom node 1014, an internet node 1016, or a combination thereof, etc.) may obtain (e.g., retrieve from memory based on at least one calculation) one or more antenna assembly configuration parameters 1070 (e.g., phase shift) that are associated with at least one predicted (e.g., expected, planned, estimated, prophesized, or a combination thereof, etc.) upcoming (e.g., future, forthcoming, imminent, or a combination thereof, etc.) orientation position 1072PUOP (e.g., a compass reading) of at least one portable wireless node 1002P (e.g., an entertainment device).

For example, an operation 502 may include an operation 1622 of obtaining one or more antenna assembly configuration parameters that are associated with at least one Euler value of the at least one portable wireless node. For instance, at least one fixed node 1002F (e.g., a telecom node 1014, an internet node 1016, or a combination thereof, etc.) may obtain (e.g., determine) one or more antenna assembly configuration parameters 1070 (e.g., subset of antenna junctions) that are associated with at least one Euler value 1072EV (e.g., a rotational angle, a rotation about one or more axes of a coordinate system, at least one of three elemental rotations, or a combination thereof, etc.) of at least one portable wireless node 1002P (e.g., a Samsung Galaxy smart phone).

For example, an operation 1622 may include an operation 1624 of obtaining one or more antenna assembly configuration parameters that are associated with at least one Euler angle of the at least one portable wireless node. For instance, at least one fixed node 1002F (e.g., a telecom node 1014, an internet node 1016, or a combination thereof, etc.) may obtain (e.g., calculate via one or more or averaging operations) one or more antenna assembly configuration parameters 1070 (e.g., resonant frequency adjustment values) that are associated with at least one Euler angle (e.g., a measure in degrees) of at least one portable wireless node 1002P (e.g., a Samsung Galaxy phablet).

For example, an operation 1622 may include an operation 1626 of obtaining one or more antenna assembly configuration parameters that are associated with at least one Euler rotation of the at least one portable wireless node. For instance, at least one fixed node 1002F (e.g., a telecom node 1014, an internet node 1016, or a combination thereof, etc.) may obtain (e.g., acquire via at least one database access) one or more antenna assembly configuration parameters 1070 (e.g., time delay) that are associated with at least one Euler rotation (e.g., an amount of rotation about an Euler axis) of at least one portable wireless node 1002P (e.g., Samsung Galaxy Tab tablet computer).

For example, an operation 502 may include an operation 1628 of obtaining the one or more antenna assembly configuration parameters that are associated with the at least one orientation position of the at least one portable wireless node with the at least one orientation position representative of at least one direction to which at least a portion of the at least one portable wireless node at least one of points or faces. For instance, at least one fixed node 1002F (e.g., a telecom node 1014, an internet node 1016, or a combination thereof, etc.) may obtain (e.g., look up in at least one table) one or more antenna assembly configuration parameters 1070 (e.g., a phased array setting) that are associated with at least one orientation position 1072OP (e.g., whether a screen is facing toward a body part or away from a body part) of at least one portable wireless node 1002P (e.g., a tablet computing device) with the at least one orientation position 1072OP representative of at least one direction (e.g., up, down, north, south, corner of building, or a combination thereof, etc.) to which at least a portion (e.g., a screen, a back, an edge, an extendible antenna, or a combination thereof, etc.) of the at least one portable wireless node 1002P at least one of points (e.g., a vector defining a position has an indicating directional angle) or faces (e.g., a surface is exposed towards a direction).

For example, an operation 502 may include an operation 1630 of obtaining one or more antenna assembly configuration parameters that are associated with the at least one orientation position of the at least one portable wireless node and that are applicable to at least one meta-material antenna. For instance, at least one fixed node 1002F (e.g., a telecom node 1014, an internet node 1016, or a combination thereof, etc.) may obtain (e.g., receive from one portable wireless node) one or more antenna assembly configuration parameters 1070 (e.g., voltage levels) that are associated with at least one orientation position 1072OP (e.g., an Euler angle) of at least one portable wireless node 1002P (e.g., a different portable wireless node, such as a user equipment) and that are applicable to at least one meta-material antenna 1006MM (e.g., a surface scattering antenna).

For example, an operation 502 may include an operation 1632 of obtaining one or more antenna assembly configuration parameters that are associated with the at least one orientation position of the at least one portable wireless node and that are applicable to at least one array-based antenna. For instance, at least one fixed node 1002F (e.g., a telecom node 1014, an internet node 1016, or a combination thereof, etc.) may obtain (e.g., acquire from a storage area network) one or more antenna assembly configuration parameters 1070 (e.g., phase shifts or beam shape or direction) that are associated with at least one orientation position 1072OP (e.g., a screen facing within 30 degrees of north and a vector along a length of a housing running within 15 degrees of parallel to a gravitational force) of at least one portable wireless node 1002P (e.g., phablet) and that are applicable to at least one array-based antenna 1006AR/1006PH/1006* (e.g., a beamforming, phased-array antenna).

FIG. 6A3 illustrates a flow diagram 600A3 having any one or more of example operations 1640-1648. For example, an operation 502 may include an operation 1640 of obtaining one or more antenna assembly configuration parameters that are associated with at least one spatial location of the at least one portable wireless node. For instance, at least one fixed node 1002F (e.g., a telecom node 1014, an internet node 1016, or a combination thereof, etc.) may obtain (e.g., receive from one or more portable wireless nodes) one or more antenna assembly configuration parameters 1070 (e.g., data that is usable to operate an antenna in a manner to form at least one directed transmission or reception) that are associated with at least one spatial location 1072SL (e.g., a geographical position, an elevation position, or a combination thereof, etc.) of at least one portable wireless node 1002P (e.g., an Amazon Kindle device).

For example, an operation 1640 may include an operation 1642 of obtaining one or more antenna assembly configuration parameters that are associated with at least one geographical position of the at least one portable wireless node. For instance, at least one fixed node 1002F (e.g., a telecom node 1014, an internet node 1016, or a combination thereof, etc.) may obtain (e.g., request from a remote hand-held communication device) one or more antenna assembly configuration parameters 1070 (e.g., a selected subset of antenna junctions) that are associated with at least one geographical position 1072GP (e.g., a postal address, one or more SPS coordinates, a room identifier, a business name, or a combination thereof, etc.) of at least one portable wireless node 1002P (e.g., an Amazon Kindle tablet).

For example, an operation 1642 may include an operation 1644 of obtaining one or more antenna assembly configuration parameters that are associated with at least one satellite positioning system (SPS) coordinate of the at least one portable wireless node. For instance, at least one fixed node 1002F (e.g., a telecom node 1014, an internet node 1016, or a combination thereof, etc.) may obtain (e.g., retrieve from a database) one or more antenna assembly configuration parameters 1070 (e.g., a set of phase shifts) that are associated with at least one satellite positioning system (SPS) coordinate 420 (e.g., at least one GPS coordinate, a GLONASS coordinate, a Galileo coordinate, or a combination thereof, etc.) of at least one portable wireless node 1002P (e.g., a Huawei cellular phone).

For example, an operation 1640 may include an operation 1646 of obtaining one or more antenna assembly configuration parameters that are associated with at least one elevation position of the at least one portable wireless node. For instance, at least one fixed node 1002F (e.g., a telecom node 1014, an internet node 1016, or a combination thereof, etc.) may obtain (e.g., extract from a storage area network (SAN)) one or more antenna assembly configuration parameters 1070 (e.g., a set of time delays) that are associated with at least one elevation position 1072EP (e.g., an altitude, a floor level, an address that corresponds to a determinable altitude, a GPS coordinate that provides altitude information, or a combination thereof, etc.) of at least one portable wireless node 1002P (e.g., an Amazon Kindle phone).

For example, an operation 1646 may include an operation 1648 of obtaining one or more antenna assembly configuration parameters that are associated with at least one floor level of the at least one portable wireless node. For instance, at least one fixed node 1002F (e.g., a telecom node 1014, an internet node 1016, or a combination thereof, etc.) may obtain (e.g., receive from another fixed node) one or more antenna assembly configuration parameters 1070 (e.g., frequency settings) that are associated with at least one floor level 422 (e.g., a third floor of a given mall) of at least one portable wireless node 1002P (e.g., an HTC One smart phone).

FIG. 6B illustrates a flow diagram 600B having any one or more of example operations 2602-2612. For example, an operation 502 may include an operation 2602 of determining the one or more antenna assembly configuration parameters that are associated with the at least one orientation position of the at least one portable wireless node based, at least partially, on one or more different antenna assembly configuration parameters that are associated with at least one different orientation position. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc.) one or more antenna assembly configuration parameters 1070 (e.g., values connoting how to transmit or receive with at least one antenna) that are associated with at least one orientation position 1072OP (e.g., a vertically-aligned orientation) of at least one portable wireless node 1002P (e.g., a Lenovo tablet hybrid) based, at least partially, on one or more different antenna assembly configuration parameters 1070D (e.g., different values connoting how to transmit or receive with at least one antenna) that are associated with at least one different orientation position 1072DOP (e.g., a non-vertically-aligned orientation, such as a 45-degree-from horizontal orientation).

For example, an operation 2602 may include an operation 2604 of determining via extrapolation the one or more antenna assembly configuration parameters that are associated with the at least one orientation position of the at least one portable wireless node based, at least partially, on the one or more different antenna assembly configuration parameters that are associated with the at least one different orientation position. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc.) via extrapolation (e.g., extension, outward prediction, estimation outside observed or known range, or a combination thereof, etc.) one or more antenna assembly configuration parameters 1070 (e.g., phase shifts) that are associated with at least one orientation position 1072OP (e.g., a first set of Euler angles) of at least one portable wireless node 1002P (e.g., a Blackberry smart phone) based, at least partially, on one or more different antenna assembly configuration parameters 1070D (e.g., different phase shifts that have been observed previously) that are associated with at least one different orientation position 1072DOP (e.g., a second set and a third set of Euler angles that are not inclusive of the first set of Euler angles).

For example, an operation 2602 may include an operation 2606 of determining via interpolation the one or more antenna assembly configuration parameters that are associated with the at least one orientation position of the at least one portable wireless node based, at least partially, on the one or more different antenna assembly configuration parameters that are associated with the at least one different orientation position. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc.) via interpolation (e.g., internal analysis, inward prediction, estimation within observed or known range, or a combination thereof, etc.) one or more antenna assembly configuration parameters 1070 (e.g., values giving a beam directionality) that are associated with at least one orientation position 1072OP (e.g., a first set of Euler angles) of at least one portable wireless node 1002P (e.g., a portable gaming device) based, at least partially, on one or more different antenna assembly configuration parameters 1070D (e.g., different values that give a beam directionality that are already known) that are associated with at least one different orientation position 1072DOP (e.g., a second set and a third set of Euler angles having a span that is inclusive of the first set of Euler angles).

For example, an operation 502 may include an operation 2608 of determining the one or more antenna assembly configuration parameters that are associated with the at least one orientation position of the at least one portable wireless node based, at least partially, on one or more different antenna assembly configuration parameters that correspond to one or more different portable wireless nodes. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc.) one or more antenna assembly configuration parameters 1070 (e.g., identified antenna elements representing at least one wireless communication direction) that are associated with at least one orientation position 1072OP (e.g., a 45-degree inclination with a screen facing upward) of at least one portable wireless node 1002P (e.g., an Acer tablet device) based, at least partially, on one or more different antenna assembly configuration parameters 1070D (e.g., identified antenna elements that represent at least one wireless communication direction and that are already known) that correspond to one or more different portable wireless nodes 1002DP (e.g., a different Acer tablet device).

For example, an operation 2608 may include an operation 2610 of determining the one or more antenna assembly configuration parameters that are associated with the at least one orientation position of the at least one portable wireless node by combining multiple different antenna assembly configuration parameters that correspond to multiple different portable wireless nodes. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc., such as using a mode, a mean, a weighted average, a recency factor, or a combination thereof, etc.) one or more antenna assembly configuration parameters 1070 (e.g., a set of antenna junctions) that are associated with at least one orientation position 1072OP (e.g., a 30-to-60-degree inclination with a screen facing upward) of at least one portable wireless node 1002P (e.g., an Acer tablet device) by combining multiple different antenna assembly configuration parameters 1070D (e.g., multiple sets of antenna junctions that represent at least one wireless communication direction and that are already known) that correspond to multiple different portable wireless nodes 1002DP (e.g., three Apple iPads and one Samsung Galaxy Tab tablet).

For example, an operation 502 may include an operation 2612 of determining the one or more antenna assembly configuration parameters that are associated with the at least one orientation position of the at least one portable wireless node based, at least partially, on one or more different antenna assembly configuration parameters that are associated with the at least one orientation position at a different spatial location entry stored in at least one antenna configuration data structure. For instance, at least one fixed node 1002F (e.g., a telecom node 1014, an internet node 1016, or a combination thereof, etc.) may determine (e.g., ascertain from evidence, figure out, calculate, interpolate, extrapolate, average, perform a statistical analysis, or a combination thereof, etc.) one or more antenna assembly configuration parameters 1070 (e.g., phase shifts for antenna junctions) that are associated with at least one orientation position 1072OP (e.g., a pitch indication and a yaw indication) of at least one portable wireless node 1002P (e.g., a smart phone) based, at least partially, on one or more different antenna assembly configuration parameters 1070D (e.g., phase shifts for antenna junctions) that are associated with at least one orientation position 1072OP (e.g., a same or proximate pitch indication or a same or proximate yaw indication) at a different spatial location entry 424 (e.g., at a stored entry for Room 2.013 if the smart phone is currently located in Room 2.014) stored in at least one antenna configuration data structure 1008 (e.g., a table, a data base, an associative memory device, or a combination thereof, etc.).

FIG. 6C illustrates a flow diagram 600C having any one or more of example operations 3602-3614. For example, an operation 502 may include an operation 3602 of receiving the one or more antenna assembly configuration parameters that are associated with the at least one orientation position of the at least one portable wireless node from at least one remote node. For instance, at least one fixed node 1002F (e.g., a telecom node 1014, an internet node 1016, or a combination thereof, etc.) may receive (e.g., accept, decode, demodulate, down-convert, detect, obtain from or via a communication or transmission from another, route from an antenna or antenna element, take into possession wirelessly or by wire, or a combination thereof, etc.) one or more antenna assembly configuration parameters 1070 (e.g., data indicating at least one direction for transceiving using at least one antenna) that are associated with at least one orientation position 1072OP (e.g., 80-110 degrees from vertical and an identifiable edge rotated 45-75 degrees west of north) of at least one portable wireless node 1002P (e.g., a mobile phone) from at least one remote node 426 (e.g., a portable wireless node, a fixed wireless node, a telecom node, an internet node, or a combination thereof, etc.).

For example, an operation 3602 may include an operation 3604 of receiving the one or more antenna assembly configuration parameters that are associated with the at least one orientation position of the at least one portable wireless node from at least one fixed wireless node. For instance, at least one fixed node 1002F (e.g., a telecom node 1014, an internet node 1016, or a combination thereof, etc.) may receive (e.g., procure from an external source) one or more antenna assembly configuration parameters 1070 (e.g., identification of at least one antenna to use to transceive) that are associated with at least one orientation position 1072OP (e.g., a direction to which at least one edge or corner of a device points) of at least one portable wireless node 1002P (e.g., a tablet computer) from at least one fixed wireless node 1002F1/F2/F3 (e.g., an access point, a base station, or a combination thereof, etc.).

For example, an operation 3602 may include an operation 3606 of receiving the one or more antenna assembly configuration parameters that are associated with the at least one orientation position of the at least one portable wireless node from at least one telecommunications node. For instance, at least one fixed node 1002F (e.g., a telecom node 1014, an internet node 1016, or a combination thereof, etc.) may receive (e.g., obtain via the internet) one or more antenna assembly configuration parameters 1070 (e.g., one or more phase shifts) that are associated with at least one orientation position 1072OP (e.g., a roll, pitch, or yaw indicator) of at least one portable wireless node 1002P (e.g., a cellular phone) from at least one telecommunications node 1014 (e.g., a server operated by a telecommunications provider, a cellular network gateway, an intelligent backbone switch or router, a mobile switching center, or a combination thereof, etc.).

For example, an operation 3602 may include an operation 3608 of receiving one or more condition and associated configuration parameters from the at least one portable wireless node. For instance, at least one fixed node 1002F (e.g., a telecom node 1014, an internet node 1016, or a combination thereof, etc.) may receive (e.g., acquire at least one message containing) one or more condition and associated configuration parameters 1074 (e.g., a message, a packet, an associative pair, a portion of a table or data structure, or a combination thereof, etc. that link a condition, such as a location or weather situation, and a configuration parameter, such as a set of antenna elements) from at least one portable wireless node 1002P (e.g., a laptop).

For example, an operation 3608 may include an operation 3610 of receiving one or more indications of at least one condition that the at least one portable wireless node experiences and one or more indications of at least one antenna assembly configuration parameter that are to be associated therewith. For instance, at least one fixed node 1002F (e.g., a telecom node 1014, an internet node 1016, or a combination thereof, etc.) may receive (e.g., capture a signal having) one or more indications (e.g., a code or a description) of at least one condition 1072 (e.g., a spatial location, an environmental factor, a counterpart wireless node, an auxiliary relay item, or a combination thereof, etc.) that at least one portable wireless node 1002P (e.g., a Motorola smart phone) experiences (e.g., is affected by, has access to, factors into an analysis, or a combination thereof, etc.) and one or more indications (e.g., a signifier or explanation) of at least one antenna assembly configuration parameter 1070 (e.g., a transceiving direction or a set of antenna junctions) that are to be associated therewith.

For example, an operation 3610 may include an operation 3612 of receiving one or more indications of at least one weather-related environmental condition that the at least one portable wireless node experiences and the one or more indications of the at least one antenna assembly configuration parameter that are to be associated therewith. For instance, at least one fixed node 1002F (e.g., a telecom node 1014, an internet node 1016, or a combination thereof, etc.) may receive (e.g., decode) one or more indications (e.g., representation) of at least one weather-related environmental condition 1072E (e.g., a humidity, a cloud cover, a temperature, a precipitation, or a combination thereof, etc.) that at least one portable wireless node 1002P (e.g., a push-to-talk radio) experiences (e.g., is impacted by, undergoes, adjusts to, becomes aware of, or a combination thereof, etc.) and one or more indications (e.g., a link to an antenna setting) of at least one antenna assembly configuration parameter 1070 (e.g., voltage level for one or more antenna control signals) that are to be associated therewith.

For example, an operation 3610 may include an operation 3614 of receiving one or more indications of at least one of a roll, a pitch, or a yaw condition that the at least one portable wireless node experiences and the one or more indications of the at least one antenna assembly configuration parameter that are to be associated therewith. For instance, at least one fixed node 1002F (e.g., a telecom node 1014, an internet node 1016, or a combination thereof, etc.) may receive (e.g., send up a protocol stack from a transport layer) one or more indications (e.g., rotational ranges in degrees or radians) of at least one of a roll, a pitch, or a yaw condition 1072RPY (e.g., a left-right, an up-down, or a combination thereof, etc. rotational status) that at least one portable wireless node 1002P (e.g., a tablet-laptop hybrid) experiences (e.g., is moved to, is reposing at, or a combination thereof, etc.) and one or more indications (e.g., numerals, processes, formulae, or a combination thereof, etc.) of at least one antenna assembly configuration parameter 1070 (e.g., signal phase adjustment) that are to be associated therewith.

FIG. 6D1 illustrates a flow diagram 600D1 having any one or more of example operations 4602-4612. For example, an operation 502 may include an operation 4602 of receiving from at least one remote node at least a portion of at least one physical state of the at least one portable wireless node. For instance, at least one fixed node 1002F (e.g., a telecom node 1014, an internet node 1016, or a combination thereof, etc.) may receive (e.g., detect arrival of an internet protocol (IP) packet, decode a message, or a combination thereof, etc.) from at least one remote node 426 (e.g., a portable wireless node, a fixed wireless node, a telecom node, an internet node, or a combination thereof, etc.) at least a portion of at least one physical state 1072PS (e.g., a spatial location, a geographical position, an elevation position, an orientation position, or a combination thereof, etc.) of at least one portable wireless node 1002P (e.g., a personal Wi-Fi-creating device).

For example, an operation 4602 may include an operation 4604 of receiving from the at least one portable wireless node at least a portion of at least one spatial location of the at least one portable wireless node. For instance, at least one fixed node 1002F (e.g., a telecom node 1014, an internet node 1016, or a combination thereof, etc.) may receive (e.g., interpret an analog or digital signal originating or derived) from at least one portable wireless node 1002P (e.g., a smart phone) at least a portion of at least one spatial location 1072SL (e.g., a geographical position such as GPS coordinates or an elevation such as a height in meters) of at least one portable wireless node 1002P (e.g., the smart phone that sent the analog or digital signal or a different smart phone).

For example, an operation 502 may include an operation 4606 of retrieving the one or more antenna assembly configuration parameters from at least one antenna configuration data structure. For instance, at least one fixed node 1002F (e.g., a telecom node 1014, an internet node 1016, or a combination thereof, etc.) may retrieve (e.g., read from memory, access a database to acquire, or a combination thereof, etc.) one or more antenna assembly configuration parameters 1070 (e.g., identified elements of an antenna) from at least one antenna configuration data structure 1008 (e.g., a distributed data base residing in the cloud).

For example, an operation 4606 may include an operation 4608 of retrieving the one or more antenna assembly configuration parameters from the at least one antenna configuration data structure responsive at least partly to at least a portion of at least one physical state of the at least one portable wireless node. For instance, at least one fixed node 1002F (e.g., a telecom node 1014, an internet node 1016, or a combination thereof, etc.) may retrieve (e.g., load from a cache memory, pull from shared memory of another processor, extract from a storage area network (SAN), or a combination thereof, etc.) one or more antenna assembly configuration parameters 1070 (e.g., multiple resonant frequency adjustor control signal values) from at least one antenna configuration data structure 1008 (e.g., a local or distributed associative storage device) responsive at least partly to at least a portion of at least one physical state 1072PS (e.g., a geographical position, such as a room identification at a street address) of at least one portable wireless node 1002P (e.g., an Asus computing device having a screen and a separate or attached keyboard).

For example, an operation 504 may include an operation 4610 of transmitting the one or more antenna assembly configuration parameters that are associated with the at least one orientation position to the at least one portable wireless node. For instance, at least one fixed node 1002F (e.g., a telecom node 1014, an internet node 1016, or a combination thereof, etc.) may transmit (e.g., send, frequency upconvert, encapsulate in one or more packets, or a combination thereof, etc.) one or more antenna assembly configuration parameters 1070 (e.g., operational control instructions or procedure to cause an antenna to transceive in a given direction) that are associated with at least one orientation position 1072OP (e.g., three Euler angles) to at least one portable wireless node 1002P (e.g., a Windows-8-based tablet).

For example, an operation 4610 may include an operation 4612 of transmitting the one or more antenna assembly configuration parameters that are associated with the at least one orientation position to the at least one portable wireless node responsive at least partly to receipt of at least a portion of at least one physical state of the at least one portable wireless node. For instance, at least one fixed node 1002F (e.g., a telecom node 1014, an internet node 1016, or a combination thereof, etc.) may transmit (e.g., send forth over the internet and via at least one wireless network link) one or more antenna assembly configuration parameters 1070 (e.g., representations of one or more antenna junctions or an antenna junction pattern) that are associated with at least one orientation position 1072OP (e.g., one or more rotational directions to which at least one edge or side points or faces relative to the earth's surface or magnetic north) to at least one portable wireless node 1002P (e.g., a smart phone) responsive at least partly to receipt (e.g., acquisition via a delivered message) of at least a portion of at least one physical state 1072PS (e.g., a set of GPS coordinates) of the at least one portable wireless node 1002P.

FIG. 6D2 illustrates a flow diagram 600D2 having any one or more of example operations 4620-4628. For example, an operation 502 may include an operation 4620 of retrieving the one or more antenna assembly configuration parameters that are associated with the at least one orientation position of the at least one portable wireless node from at least one data structure that is accessible to at least one server. For instance, at least one fixed node 1002F (e.g., a telecom node 1014, an internet node 1016, or a combination thereof, etc.) may retrieve (e.g., read from memory) one or more antenna assembly configuration parameters 1070 (e.g., a set of phase shifts) that are associated with at least one orientation position 1072OP (e.g., one or more sensor values provided by a compass or an accelerometer) of at least one portable wireless node 1002P (e.g., an Apple iPhone) from at least one data structure 428 (e.g., a database) that is accessible to at least one server 430 (e.g., one or more server blades in a server farm).

For example, an operation 4620 may include an operation 4622 of applying at least one spatial location of the at least one portable wireless node to at least one antenna configuration data structure that is accessible to the at least one server. For instance, at least one fixed node 1002F (e.g., a telecom node 1014, an internet node 1016, or a combination thereof, etc.) may apply (e.g., provide as a search term, input an address responsive to, or a combination thereof, etc.) at least one spatial location 1072SL (e.g., one or more GPS coordinates) of at least one portable wireless node 1002P (e.g., an Apple iPad) to at least one antenna configuration data structure 1008 (e.g., a distributed cloud-based storage apparatus) that is accessible to at least one server 430 (e.g., a computing device that provides cloud services).

For example, an operation 4622 may include an operation 4624 of extracting the one or more antenna assembly configuration parameters from the at least one antenna configuration data structure that is accessible to the at least one server responsive at least partially to application of the at least one spatial location of the at least one portable wireless node. For instance, at least one fixed node 1002F (e.g., a telecom node 1014, an internet node 1016, or a combination thereof, etc.) may extract (e.g., pull or recall) one or more antenna assembly configuration parameters 1070 (e.g., one or more identified antenna elements) from at least one antenna configuration data structure 1008 (e.g., at least a portion of a table linking conditions to parameters) that is accessible to at least one server 430 (e.g., a virtualized computing entity) responsive at least partially to application (e.g., submission, insertion, forwarding, or a combination thereof, etc.) of at least one spatial location 1072SL (e.g., a street address) of at least one portable wireless node 1002P (e.g., a Motorola Zoom tablet computer).

For example, an operation 504 may include an operation 4626 of storing the one or more antenna assembly configuration parameters, which are received from at least one remote node, with at least one antenna configuration data structure. For instance, at least one fixed node 1002F (e.g., a telecom node 1014, an internet node 1016, or a combination thereof, etc.) may store (e.g., write, enter, provide for retention, or a combination thereof, etc.) one or more antenna assembly configuration parameters 1070 (e.g., amplitude-setting control signal values), which are received (e.g., accepted via at least one packet) from at least one remote node 426 (e.g., a portable wireless node, a fixed wireless node, a telecom node, an internet node, or a combination thereof, etc.), with (e.g., by, in, using, or a combination thereof, etc.) at least one antenna configuration data structure 1008 (e.g., an indexed data base).

For example, an operation 4626 may include an operation 4628 of updating at least one preexisting antenna assembly configuration parameter already stored with the at least one antenna configuration data structure using the one or more antenna assembly configuration parameters that are received from the at least one remote node. For instance, at least one fixed node 1002F (e.g., a telecom node 1014, an Internet node 1016, or a combination thereof, etc.) may update (e.g., alter, augment, add to, replace, modify or a combination thereof, etc.) at least one preexisting (e.g., previously acquired) antenna assembly configuration parameter 1070 (e.g., phased-array operational control value) already stored (e.g., previously retained in a retrieval format) with (e.g., by, in, using, or a combination thereof, etc.) at least one antenna configuration data structure 1008 (e.g., an associative table distributed to geographically proximate sights) using one or more antenna assembly configuration parameters 1070 (e.g., phased-array operational control value) that are received (e.g., accepted and decrypted) from at least one remote node 426 (e.g., a portable wireless node, a fixed wireless node, a telecom node, an internet node, or a combination thereof, etc., such as a same remote node at a different time or a different remote node at a same or a different time).

FIG. 6E illustrates a flow diagram 600E having any one or more of example operations 5602-5616. For example, an operation 504 may include an operation 5602 of transmitting the one or more antenna assembly configuration parameters that are associated with the at least one orientation position of the at least one portable wireless node. For instance, at least one fixed node 1002F (e.g., a telecom node 1014, an internet node 1016, or a combination thereof, etc., such as a Google server) may transmit (e.g., send, communicate by wire, communicate wirelessly, frequency up-convert, modulate, encode, propagate, emanate from an emitter or antenna or network port, or a combination thereof, etc.) one or more antenna assembly configuration parameters 1070 (e.g., indication of at least one particular antenna patch) that are associated with at least one orientation position 1072OP (e.g., a vector representing a normal to a screen) of at least one portable wireless node 1002P (e.g., an Android smart phone).

For example, an operation 5602 may include an operation 5604 of transmitting the one or more antenna assembly configuration parameters responsive at least partly to reception of the at least one orientation position of the at least one portable wireless node. For instance, at least one fixed node 1002F (e.g., a telecom node 1014, an internet node 1016, or a combination thereof, etc., such as a gateway or base station operated by at&t) may transmit (e.g., wirelessly propagate) one or more antenna assembly configuration parameters 1070 (e.g., phase delays) responsive at least partly to reception of (e.g., obtainment of a wireless signal indicating) at least one orientation position 1072OP (e.g., a value from an inertial measurement unit (IMU)) of at least one portable wireless node 1002P (e.g., an HTC phone).

For example, an operation 5602 may include an operation 5606 of transmitting the one or more antenna assembly configuration parameters responsive at least partly to reception of at least a portion of at least one physical state of the at least one portable wireless node. For instance, at least one fixed node 1002F (e.g., a telecom node 1014, an internet node 1016, or a combination thereof, etc., such as an Apple cloud server) may transmit (e.g., send onto an internet backbone) one or more antenna assembly configuration parameters 1070 (e.g., resonant frequency adjustor values) responsive at least partly to reception (e.g., acquisition via a network port) of at least a portion of at least one physical state 1072PS (e.g., a rotational position in 3-D space) of at least one portable wireless node 1002P (e.g., an Apple iPhone).

For example, an operation 5606 may include an operation 5608 of transmitting the one or more antenna assembly configuration parameters responsive at least partly to reception of at least a portion of at least one spatial location of the at least one portable wireless node. For instance, at least one fixed node 1002F (e.g., a telecom node 1014, an internet node 1016, or a combination thereof, etc., such as an Apple virtualized server) may transmit (e.g., send down a network protocol stack to a transport layer) one or more antenna assembly configuration parameters 1070 (e.g., a set of antenna junctions) responsive at least partly to reception (e.g., acquisition) of at least a portion of at least one spatial location 1072SL (e.g., a location relative to a known Wi-Fi access point) of at least one portable wireless node 1002P (e.g., an Apple iPad).

For example, an operation 5602 may include an operation 5610 of transmitting multiple antenna assembly configuration parameters for multiple orientation positions that correspond to at least one spatial location of the at least one portable wireless node. For instance, at least one fixed node 1002F (e.g., a telecom node 1014, an internet node 1016, or a combination thereof, etc., such as a Google server farm) may transmit (e.g., send a signal over a wire for) multiple antenna assembly configuration parameters 1070 (e.g., multiple identified antenna junction sets) for multiple orientation positions 1072OP (e.g., multiple ranges of inclinations or declinations) that correspond to at least one spatial location 1072SL (e.g., GPS coordinates) of at least one portable wireless node 1002P (e.g., an Android tablet).

For example, an operation 5610 may include an operation 5612 of transmitting the multiple antenna assembly configuration parameters for the multiple orientation positions that correspond to at least one current spatial location of the at least one portable wireless node. For instance, at least one fixed node 1002F (e.g., a telecom node 1014, an internet node 1016, or a combination thereof, etc., such as a Verizon server) may transmit (e.g., formulate message having) multiple antenna assembly configuration parameters 1070 (e.g., temporal delays) for multiple orientation positions 1072OP (e.g., 0-45 degrees, 46-90 degrees, 91-135 degrees, and 136-180 degrees along at least one axis) that correspond to at least one current (e.g., contemporaneous, not past or future, based on most recent knowledge or data or determination, or a combination thereof, etc.) spatial location 1072SL (e.g., GPS coordinates) of at least one portable wireless node 1002P (e.g., a flying unmanned aerial vehicle (UAV)).

For example, an operation 5610 may include an operation 5614 of transmitting the multiple antenna assembly configuration parameters for the multiple orientation positions that correspond to at least one predicted spatial location of the at least one portable wireless node. For instance, at least one fixed node 1002F (e.g., a telecom node 1014, an internet node 1016, or a combination thereof, etc., such as a Samsung server device) may transmit (e.g., propagate at least one signal or packet) multiple antenna assembly configuration parameters 1070 (e.g., multiple antenna element indications) for multiple orientation positions 1072OP (e.g., four zones between horizontal and vertical and eight zones rotating around a vertical axis) that correspond to at least one predicted (e.g., expected, planned, estimated, prophesized, or a combination thereof, etc.) spatial location 1072SL (e.g., physical address) of at least one portable wireless node 1002P (e.g., a Samsung Galaxy tablet).

For example, an operation 5614 may include an operation 5616 of transmitting the multiple antenna assembly configuration parameters for the multiple orientation positions that correspond to the at least one predicted spatial location of the at least one portable wireless node responsive at least partly to at least one reception of the at least one predicted spatial location of the at least one portable wireless node. For instance, at least one fixed node 1002F (e.g., a telecom node 1014, an internet node 1016, or a combination thereof, etc., such as part of a Samsung server farm) may transmit (e.g., supply a packet to a network) multiple antenna assembly configuration parameters 1070 (e.g., multiple phase delay sets) for multiple orientation positions 1072OP (e.g., multiple rotation-defined zones in Euler values) that correspond to at least one predicted (e.g., expected, planned, estimated, prophesized, or a combination thereof, etc. based on a history or a current velocity vector) spatial location 1072SL (e.g., GPS coordinates) of at least one portable wireless node 1002P (e.g., a Samsung Galaxy smart phone) responsive at least partly to at least one reception (e.g., ascertainment via at least one datum received from a portable wireless node or another fixed node) of the at least one predicted spatial location 1072SL of the at least one portable wireless node 1002P.

FIG. 6F illustrates a flow diagram 600F having any one or more of example operations 6602-6614. For example, an operation 504 may include an operation 6602 of downloading, by at least one fixed node, at least a cacheable portion of an antenna configuration data structure to one or more portable wireless nodes. For instance, at least one fixed node 1002F (e.g., a telecom node 1014, an internet node 1016, or a combination thereof, etc.) may download (e.g., send to, transmit toward, cause another to forward, instruct another to receive, or a combination thereof, etc.) [by the at least one fixed node 1002F (e.g., a server device coupled to the internet)] at least a cacheable portion 432 (e.g., a portion that is sufficiently small such that it can be stored locally) of an antenna configuration data structure 1008 (e.g., a database) to one or more portable wireless nodes 1002P (e.g., smart phones).

For example, an operation 6602 may include an operation 6604 of downloading, by the at least one fixed node, the at least a cacheable portion of the antenna configuration data structure to the one or more portable wireless nodes based, at least partially, on at least one density of one or more entries of the antenna configuration data structure. For instance, at least one fixed node 1002F (e.g., a telecom node 1014, an internet node 1016, or a combination thereof, etc.) may download (e.g., send towards another device or entity) [by the at least one fixed node 1002F (e.g., a Google server)] at least a cacheable portion 432 (e.g., a portion that pertains to a receiving entity's proximate surroundings) of an antenna configuration data structure 1008 (e.g., a distributed database) to one or more portable wireless nodes 1002P (e.g., an Android tablet computer) based, at least partially, on at least one density (e.g., number of parameters per condition, number of entries for a given physical state, number of orientation position variables per spatial location unit, or a combination thereof, etc.) of one or more entries 424 (e.g., associations or linkages between at least one condition and at least one parameter) of the antenna configuration data structure 1008.

For example, an operation 6604 may include an operation 6606 of downloading, by the at least one fixed node, the at least a cacheable portion of the antenna configuration data structure to the one or more portable wireless nodes based, at least partially, on a number of entries per spatial location granularity of the antenna configuration data structure. For instance, at least one fixed node 1002F (e.g., a telecom node 1014, an internet node 1016, or a combination thereof, etc.) may download (e.g., cause another device to receive) [by the at least one fixed node 1002F (e.g., a device providing a Google cloud service)] at least a cacheable portion 432 (e.g., a portion that is of a size that it can be downloaded as needed by a portable device) of an antenna configuration data structure 1008 (e.g., a table linking phase shifts to rotational positions) to one or more portable wireless nodes 1002P (e.g., an Android smart phone) based, at least partially, on a number of entries 424 (e.g., a phase shift-rotational position coupled linkage) per spatial location granularity (e.g., size of spatial location, length between two consecutive spatial location borders, number of spatial location entries per unit of area—such as per square kilometer or for a given room in a restaurant, 5 feet or 10 meters, a distance within which one or more antenna configuration parameters for a given orientation position may be considered adequate or unchanging, or a combination thereof, etc.) of the antenna configuration data structure 1008.

For example, an operation 6602 may include an operation 6608 of downloading, by the at least one fixed node, the at least a cacheable portion of the antenna configuration data structure to the one or more portable wireless nodes based, at least partially, on one or more cache sizes requested by the one or more portable wireless nodes. For instance, at least one fixed node 1002F (e.g., a telecom node 1014, an internet node 1016, or a combination thereof, etc.) may download (e.g., send over the Internet to) [by the at least one fixed node 1002F (e.g., a Verizon server or gateway)] at least a cacheable portion 432 (e.g., a size in bytes that a device can store locally in its own memory) of an antenna configuration data structure 1008 (e.g., an associated table) to one or more portable wireless nodes 1002P (e.g., personal Wi-Fi-creating devices) based, at least partially, on one or more cache sizes (e.g., 5 MB, 25-50 MB, a size that can be received in less than 0.5 seconds given network constraints, or a combination thereof, etc.) requested by (e.g., asked for, petitioned by, demanded by, or a combination thereof, etc.) the one or more portable wireless nodes 1002P.

For example, an operation 6602 may include an operation 6610 of downloading, by the at least one fixed node, the at least a cacheable portion of the antenna configuration data structure to the one or more portable wireless nodes based, at least partially, on one or more speeds of the one or more portable wireless nodes. For instance, at least one fixed node 1002F (e.g., a telecom node 1014, an internet node 1016, or a combination thereof, etc.) may download (e.g., cause another to accept) [by the at least one fixed node 1002F (e.g., a part of a Nokia server farm)] at least a cacheable portion 432 (e.g., a part that can be received in time to use with respect to a given spatial location) of an antenna configuration data structure 1008 (e.g., an associative storage unit having antenna elements linked to Euler angles of a device) to one or more portable wireless nodes 1002P (e.g., smart phones) based, at least partially, on one or more speeds (e.g., magnitude of velocity, rate at which position changes over time, rapidity of movement, amount of time a mobile device is likely to remain within a given spatial location, or a combination thereof, etc.) of the one or more portable wireless nodes 1002P.

For example, an operation 6602 may include an operation 6612 of downloading, by the at least one fixed node, the at least a cacheable portion of the antenna configuration data structure to the one or more portable wireless nodes based, at least partially, on one or more locations of the one or more portable wireless nodes. For instance, at least one fixed node 1002F (e.g., a telecom node 1014, an internet node 1016, or a combination thereof, etc.) may download (e.g., transmit towards) [by the at least one fixed node 1002F (e.g., an Apple server device)] at least a cacheable portion 432 (e.g., a part that may be stored within a designated antenna configuration parameter memory size) of an antenna configuration data structure 1008 (e.g., a database accessible to a server farm) to one or more portable wireless nodes 1002P (e.g., an Apple iPhone) based, at least partially, on one or more locations (e.g., a current spatial location, a predicted spatial location, GPS coordinates, a room identification, furniture identification, or a combination thereof, etc.) of the one or more portable wireless nodes 1002P.

For example, an operation 6612 may include an operation 6614 of downloading, by the at least one fixed node, the at least a cacheable portion of the antenna configuration data structure to the one or more portable wireless nodes based, at least partially, on one or more distances of the one or more portable wireless nodes to one or more boundaries of one or more entries of the antenna configuration data structure. For instance, at least one fixed node 1002F (e.g., a telecom node 1014, an internet node 1016, or a combination thereof, etc.) may download (e.g., transmit towards another entity and ask the other entity to accept) [by the at least one fixed node 1002F (e.g., a device running an Apple iCloud service)] at least a cacheable portion 432 (e.g., a part that can be managed by a portable device) of an antenna configuration data structure 1008 (e.g., a database having antenna configuration parameters, such as indicated directions of transmission, in association with conditions that may be experienced by a portable device, such as physical state or weather) to one or more portable wireless nodes 1002P (e.g., an Apple iWatch) based, at least partially, on one or more distances (e.g., inches, feet, meters, length of a pathway, or a combination thereof, etc.) of the one or more portable wireless nodes 1002P to one or more boundaries 426 (e.g., a demarcation between one spatial location and an adjacent spatial location, a zone in which recommended antenna configuration parameters transition from one set to another set, 45 and 90 degrees, every 3 degrees in rotation, every 1.5 meters in linear distance, every 10 feet in altitude, or a combination thereof, etc.) of one or more entries 424 (e.g., at least one linkage between a spatial location and an indicated direction for reception) of the antenna configuration data structure 1008.

FIG. 6G illustrates a flow diagram 600G having any one or more of example operations 7602-7618. For example, an operation 504 may include an operation 7602 of storing the one or more antenna assembly configuration parameters in association with at least one indication. For instance, at least one fixed node 1002F (e.g., a telecom node 1014, an Internet node 1016, or a combination thereof, etc.) may store (e.g., save, write, add to or modify an entry, create a database entry, memorialize, or a combination thereof, etc.) one or more antenna assembly configuration parameters 1070 (e.g., indicator of electromagnetic radiation directionality for receiving or transmitting) in association with at least one indication 428 (e.g., a description, a designation, an expression, a sign, evidence, a representation, an indirect identification, a direct identification, a reference, a code providing a linkage to, a signal, a value, a showing, or a combination thereof, etc.).

For example, an operation 7602 may include an operation 7604 of storing the one or more antenna assembly configuration parameters in association with at least one indication of at least one time of ascertainment. For instance, at least one fixed node 1002F (e.g., a telecom node 1014, an internet node 1016, or a combination thereof, etc.) may store (e.g., record) one or more antenna assembly configuration parameters 1070 (e.g., antenna elements to be used in transceiving) in association with at least one indication 428 (e.g., a temporal value) of at least one time of ascertainment 430 (e.g., a day, a date, a time of day, or a combination thereof, etc.).

For example, an operation 7602 may include an operation 7606 of storing the one or more antenna assembly configuration parameters in association with at least one indication of at least one type of ascertaining device. For instance, at least one fixed node 1002F (e.g., a telecom node 1014, an internet node 1016, or a combination thereof, etc.) may store (e.g., save) one or more antenna assembly configuration parameters 1070 (e.g., resonant frequency adjustment values) in association with at least one indication 428 (e.g., a description or designation) of at least one type of ascertaining device 432 (e.g., a phone or a tablet or a laptop; a brand such as Samsung or HTC; a model such as Apple iPhone 5 or Samsung Galaxy S4; a specific model such as a stock keeping unit (SKU) identifier; or a combination thereof; etc.).

For example, an operation 7602 may include an operation 7608 of storing the one or more antenna assembly configuration parameters in association with at least one indication of at least one measure of signal quality. For instance, at least one fixed node 1002F (e.g., a telecom node 1014, an internet node 1016, or a combination thereof, etc.) may store (e.g., add to an entry in a data base) one or more antenna assembly configuration parameters 1070 (e.g., set of phase shifts) in association with at least one indication 428 (e.g., an expression having a value or a range) of at least one measure of signal quality 434 (.g., indicator of signal quality, representation of ability to communicate data, signal strength, error rate, signal-to-noise (SNR) value, bit error rate (BER), throughput bandwidth, energy expenditure-to-bandwidth ratio, statistical value, ability to reduce power and maintain communication capability, or a combination thereof, etc.).

For example, an operation 7602 may include an operation 7610 of storing the one or more antenna assembly configuration parameters in association with at least one indication of at least one measure of power. For instance, at least one fixed node 1002F (e.g., a telecom node 1014, an internet node 1016, or a combination thereof, etc.) may store (e.g., modify or update a database entry using) one or more antenna assembly configuration parameters 1070 (e.g., identification of antenna junctions) in association with at least one indication 428 (e.g., reference to or representation) of at least one measure of power 436 (e.g., instantaneous power, continuous power, power consumption, power reserves, transmitting power, processing power, power saved, or a combination thereof, etc.).

For example, an operation 7602 may include an operation 7612 of storing the one or more antenna assembly configuration parameters in association with at least one indication of at least one counterpart fixed wireless node. For instance, at least one fixed node 1002F (e.g., a telecom node 1014, an internet node 1016, or a combination thereof, etc.) may store (e.g., retain) one or more antenna assembly configuration parameters 1070 (e.g., one or more temporal delays) in association with at least one indication 428 (e.g., identification) of at least one counterpart (e.g., in communication with) fixed wireless node 438 (e.g., access point (AP), base station (BS), or a combination thereof, etc.).

For example, an operation 504 may include an operation 7614 of linking the one or more antenna assembly configuration parameters with map data. For instance, at least one fixed node 1002F (e.g., a telecom node 1014, an internet node 1016, or a combination thereof, etc.) may link (e.g., combine, merge, blend, reversibly or irreversibly fuse, cross-reference, amalgamate, interrelate, unite, conglomerate, synthesize, intermingle, unidirectionally or bidirectionally reference, or a combination thereof, etc.) one or more antenna assembly configuration parameters 1070 (e.g., one or more identified antenna junctions) with map data 440 (e.g., a symbolic representation of part of the world, a representation of geography, a representation of human-made structures, a three-dimensional model of the earth or a surface portion thereof, a representation of objects or forces that may impact wireless communication with respect to their position or location, or a combination thereof, etc.).

For example, an operation 7614 may include an operation 7616 of linking the one or more antenna assembly configuration parameters with radio map data. For instance, at least one fixed node 1002F (e.g., a telecom node 1014, an internet node 1016, or a combination thereof, etc.) may link (e.g., combine or include a reference to) one or more antenna assembly configuration parameters 1070 (e.g., voltage values) with radio map data 440R (e.g., signal strength indications linked to physical positions, wireless frequency coverage mated to geographical data, or a combination thereof, etc.).

For example, an operation 7614 may include an operation 7618 of linking the one or more antenna assembly configuration parameters with geospatial map data. For instance, at least one fixed node 1002F (e.g., a telecom node 1014, an internet node 1016, or a combination thereof, etc.) may link (e.g., blend or join or merge) one or more antenna assembly configuration parameters 1070 (e.g., directional indication such as 15 degrees west of north in the azimuth and 43 degrees above the horizon) with geospatial map data 440G (e.g., data symbolizing geography, linkages between representations of structures of or on the earth and their locations, data connoting or denoting three-dimensional features of the earth or human-made structures thereof—such as buildings or furniture, or a combination thereof, etc.).

Those skilled in the art will appreciate that the foregoing specific exemplary processes and/or machines and/or technologies are representative of more general processes and/or machines and/or technologies taught elsewhere herein, such as in the claims filed herewith and/or elsewhere in the present application.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/ /implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Modules, logic, circuitry, hardware and software combinations, firmware, or so forth may be realized or implemented as one or more general-purpose processors, one or more processing cores, one or more special-purpose processors, one or more microprocessors, at least one Application-Specific Integrated Circuit (ASIC), at least one Field Programmable Gate Array (FPGA), at least one digital signal processor (DSP), some combination thereof, or so forth that is executing or is configured to execute instructions, a special-purpose program, an application, software, code, some combination thereof, or so forth as at least one special-purpose computing apparatus or specific computing component. One or more modules, logic, or circuitry, etc. may, by way of example but not limitation, be implemented using one processor or multiple processors that are configured to execute instructions (e.g., sequentially, in parallel, at least partially overlapping in a time-multiplexed fashion, at least partially overlapping across multiple cores, or a combination thereof, etc.) to perform a method or realize a particular computing machine. For example, a first module may be embodied by a given processor executing a first set of instructions at or during a first time, and a second module may be embodied by the same given processor executing a second set of instructions at or during a second time. Moreover, the first and second times may be at least partially interleaved or overlapping, such as in a multi-threading, pipelined, or predictive processing environment. As an alternative example, a first module may be embodied by a first processor executing a first set of instructions, and a second module may be embodied by a second processor executing a second set of instructions. As another alternative example, a particular module may be embodied partially by a first processor executing at least a portion of a particular set of instructions and embodied partially by a second processor executing at least a portion of the particular set of instructions. Other combinations of instructions, a program, an application, software, or code, etc. in conjunction with at least one processor or other execution machinery may be utilized to realize one or more modules, logic, or circuitry, etc. to implement any of the processing algorithms described herein.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“laaS”), platform-as-a-service (“PaaS”), software-as-a-service (“SaaS”), and/or desktop-as-a-service (“DaaS”). As a non-exclusive example, laaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application —all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

This application may make reference to one or more trademarks, e.g., a word, letter, symbol, or device adopted by one manufacturer or merchant and used to identify and distinguish his or her product from those of others. Trademark names used herein are set forth in such language that makes clear their identity, that distinguishes them from common descriptive nouns, that have fixed and definite meanings, and, in many if not all cases, are accompanied by other specific identification using terms not covered by trademark. In addition, trademark names used herein have meanings that are well-known and defined in the literature, and do not refer to products or compounds protected by trade secrets in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or [trade], even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for facilitating wireless communication in conjunction with orientation position, the method being at least partially implemented by at least one device, the method comprising:
obtaining one or more antenna assembly configuration parameters that are associated with at least one orientation position of at least one portable wireless node; and
managing the one or more antenna assembly configuration parameters that are associated with the at least one orientation position of the at least one portable wireless node.

2. The method of claim 1, wherein the obtaining one or more antenna assembly configuration parameters that are associated with at least one orientation position of at least one portable wireless node comprises:
obtaining one or more indications of one or more phase shift values that are associated with the at least one orientation position of the at least one portable wireless node.

3. (canceled)

4. (canceled)

5. The method of claim 1, wherein the obtaining one or more antenna assembly configuration parameters that are associated with at least one orientation position of at least one portable wireless node comprises:
obtaining one or more indications of one or more antenna element subsets that are associated with the at least one orientation position of the at least one portable wireless node.

6. The method of claim 1, wherein the obtaining one or more antenna assembly configuration parameters that are associated with at least one orientation position of at least one portable wireless node comprises:
obtaining one or more indications of one or more resonant frequency adjustor control values that are associated with the at least one orientation position of the at least one portable wireless node.

7. (canceled)

8. The method of claim 1, wherein the obtaining one or more antenna assembly configuration parameters that are associated with at least one orientation position of at least one portable wireless node comprises:
obtaining the one or more antenna assembly configuration parameters that are associated with the at least one orientation position of the at least one portable wireless node responsive at least partly to an existence of at least one auxiliary relay item that is wirelessly linked to the at least one portable wireless node.

9. (canceled)

10. The method of claim 1, wherein the obtaining one or more antenna assembly configuration parameters that are associated with at least one orientation position of at least one portable wireless node comprises:
obtaining one or more antenna assembly configuration parameters that are associated with at least one predicted upcoming orientation position of the at least one portable wireless node.

11. The method of claim 1, wherein the obtaining one or more antenna assembly configuration parameters that are associated with at least one orientation position of at least one portable wireless node comprises:
obtaining one or more antenna assembly configuration parameters that are associated with at least one Euler value of the at least one portable wireless node.

12. (canceled)

13. (canceled)

14. The method of claim 1, wherein the obtaining one or more antenna assembly configuration parameters that are associated with at least one orientation position of at least one portable wireless node comprises:
obtaining the one or more antenna assembly configuration parameters that are associated with the at least one orientation position of the at least one portable wireless node with the at least one orientation position representative of at least one direction to which at least a portion of the at least one portable wireless node at least one of points or faces.

15. The method of claim 1, wherein the obtaining one or more antenna assembly configuration parameters that are associated with at least one orientation position of at least one portable wireless node comprises:
obtaining one or more antenna assembly configuration parameters that are associated with the at least one orientation position of the at least one portable wireless node and that are applicable to at least one meta-material antenna.

16. The method of claim 1, wherein the obtaining one or more antenna assembly configuration parameters that are associated with at least one orientation position of at least one portable wireless node comprises:
obtaining one or more antenna assembly configuration parameters that are associated with the at least one orientation position of the at least one portable wireless node and that are applicable to at least one array-based antenna.

17. The method of claim 1, wherein the obtaining one or more antenna assembly configuration parameters that are associated with at least one orientation position of at least one portable wireless node comprises:
obtaining one or more antenna assembly configuration parameters that are associated with at least one spatial location of the at least one portable wireless node.

18. The method of claim 17, wherein the obtaining one or more antenna assembly configuration parameters that are associated with at least one spatial location of the at least one portable wireless node comprises:
obtaining one or more antenna assembly configuration parameters that are associated with at least one geographical position of the at least one portable wireless node.

19. (canceled)

20. The method of claim 17, wherein the obtaining one or more antenna assembly configuration parameters that are associated with at least one spatial location of the at least one portable wireless node comprises:
obtaining one or more antenna assembly configuration parameters that are associated with at least one elevation position of the at least one portable wireless node.

21. (canceled)

22. The method of claim 1, wherein the obtaining one or more antenna assembly configuration parameters that are associated with at least one orientation position of at least one portable wireless node comprises:
determining the one or more antenna assembly configuration parameters that are associated with the at least one orientation position of the at least one portable wireless node based, at least partially, on one or more different antenna assembly configuration parameters that are associated with at least one different orientation position.

23. (canceled)

24. (canceled)

25. The method of claim 1, wherein the obtaining one or more antenna assembly configuration parameters that are associated with at least one orientation position of at least one portable wireless node comprises:
determining the one or more antenna assembly configuration parameters that are associated with the at least one orientation position of the at least one portable wireless node based, at least partially, on one or more different antenna assembly configuration parameters that correspond to one or more different portable wireless nodes.

26. The method of claim 25, wherein the determining the one or more antenna assembly configuration parameters that are associated with the at least one orientation position of the at least one portable wireless node based, at least partially, on one or more different antenna assembly configuration parameters that correspond to one or more different portable wireless nodes comprises:
determining the one or more antenna assembly configuration parameters that are associated with the at least one orientation position of the at least one portable wireless node by combining multiple different antenna assembly configuration parameters that correspond to multiple different portable wireless nodes.

27. (canceled)

28. The method of claim 1, wherein the obtaining one or more antenna assembly configuration parameters that are associated with at least one orientation position of at least one portable wireless node comprises:
receiving the one or more antenna assembly configuration parameters that are associated with the at least one orientation position of the at least one portable wireless node from at least one remote node.

29. The method of claim 28, wherein the receiving the one or more antenna assembly configuration parameters that are associated with the at least one orientation position of the at least one portable wireless node from at least one remote node comprises:
receiving the one or more antenna assembly configuration parameters that are associated with the at least one orientation position of the at least one portable wireless node from at least one fixed wireless node.

30. (canceled)

31. The method of claim 28, wherein the receiving the one or more antenna assembly configuration parameters that are associated with the at least one orientation position of the at least one portable wireless node from at least one remote node comprises:
receiving one or more condition and associated configuration parameters from the at least one portable wireless node.

32. The method of claim 31, wherein the receiving one or more condition and associated configuration parameters from the at least one portable wireless node comprises:
receiving one or more indications of at least one condition that the at least one portable wireless node experiences and one or more indications of at least one antenna assembly configuration parameter that are to be associated therewith.

33. (canceled)

34. (canceled)

35. The method of claim 1, wherein the obtaining one or more antenna assembly configuration parameters that are associated with at least one orientation position of at least one portable wireless node comprises:
receiving from at least one remote node at least a portion of at least one physical state of the at least one portable wireless node.

36. (canceled)

37. The method of claim 1, wherein the obtaining one or more antenna assembly configuration parameters that are associated with at least one orientation position of at least one portable wireless node comprises:
retrieving the one or more antenna assembly configuration parameters from at least one antenna configuration data structure.

38. The method of claim 37, wherein the retrieving the one or more antenna assembly configuration parameters from at least one antenna configuration data structure comprises:
retrieving the one or more antenna assembly configuration parameters from the at least one antenna configuration data structure responsive at least partly to at least a portion of at least one physical state of the at least one portable wireless node.

39. The method of claim 1, wherein the managing the one or more antenna assembly configuration parameters that are associated with the at least one orientation position of the at least one portable wireless node comprises:
transmitting the one or more antenna assembly configuration parameters that are associated with the at least one orientation position to the at least one portable wireless node.

40-43. (canceled)

44. The method of claim 1, wherein the managing the one or more antenna assembly configuration parameters that are associated with the at least one orientation position of the at least one portable wireless node comprises:
storing the one or more antenna assembly configuration parameters, which are received from at least one remote node, with at least one antenna configuration data structure.

45. (canceled)

46. The method of claim 1, wherein the managing the one or more antenna assembly configuration parameters that are associated with the at least one orientation position of the at least one portable wireless node comprises:
transmitting the one or more antenna assembly configuration parameters that are associated with the at least one orientation position of the at least one portable wireless node.

47. The method of claim 46, wherein the transmitting the one or more antenna assembly configuration parameters that are associated with the at least one orientation position of the at least one portable wireless node comprises:
transmitting the one or more antenna assembly configuration parameters responsive at least partly to reception of the at least one orientation position of the at least one portable wireless node.

48. The method of claim 46, wherein the transmitting the one or more antenna assembly configuration parameters that are associated with the at least one orientation position of the at least one portable wireless node comprises:
transmitting the one or more antenna assembly configuration parameters responsive at least partly to reception of at least a portion of at least one physical state of the at least one portable wireless node.

49. (canceled)

50. The method of claim 46, wherein the transmitting the one or more antenna assembly configuration parameters that are associated with the at least one orientation position of the at least one portable wireless node comprises:
transmitting multiple antenna assembly configuration parameters for multiple orientation positions that correspond to at least one spatial location of the at least one portable wireless node.

51. (canceled)

52. The method of claim 50, wherein the transmitting multiple antenna assembly configuration parameters for multiple orientation positions that correspond to at least one spatial location of the at least one portable wireless node comprises:
transmitting the multiple antenna assembly configuration parameters for the multiple orientation positions that correspond to at least one predicted spatial location of the at least one portable wireless node.

53. (canceled)

54. The method of claim 1, wherein the managing the one or more antenna assembly configuration parameters that are associated with the at least one orientation position of the at least one portable wireless node comprises:
downloading, by at least one fixed node, at least a cacheable portion of an antenna configuration data structure to one or more portable wireless nodes.

55. The method of claim 54, wherein the downloading, by at least one fixed node, at least a cacheable portion of an antenna configuration data structure to one or more portable wireless nodes comprises:
downloading, by the at least one fixed node, the at least a cacheable portion of the antenna configuration data structure to the one or more portable wireless nodes based, at least partially, on at least one density of one or more entries of the antenna configuration data structure.

56. (canceled)

57. The method of claim 54, wherein the downloading, by at least one fixed node, at least a cacheable portion of an antenna configuration data structure to one or more portable wireless nodes comprises:
downloading, by the at least one fixed node, the at least a cacheable portion of the antenna configuration data structure to the one or more portable wireless nodes based, at least partially, on one or more cache sizes requested by the one or more portable wireless nodes.

58. The method of claim 54, wherein the downloading, by at least one fixed node, at least a cacheable portion of an antenna configuration data structure to one or more portable wireless nodes comprises:
downloading, by the at least one fixed node, the at least a cacheable portion of the antenna configuration data structure to the one or more portable wireless nodes based, at least partially, on one or more speeds of the one or more portable wireless nodes.

59. The method of claim 54, wherein the downloading, by at least one fixed node, at least a cacheable portion of an antenna configuration data structure to one or more portable wireless nodes comprises:
downloading, by the at least one fixed node, the at least a cacheable portion of the antenna configuration data structure to the one or more portable wireless nodes based, at least partially, on one or more locations of the one or more portable wireless nodes.

60. (canceled)

61. The method of claim 1, wherein the managing the one or more antenna assembly configuration parameters that are associated with the at least one orientation position of the at least one portable wireless node comprises:
storing the one or more antenna assembly configuration parameters in association with at least one indication.

62. (canceled)

63. The method of claim 61, wherein the storing the one or more antenna assembly configuration parameters in association with at least one indication comprises:
storing the one or more antenna assembly configuration parameters in association with at least one indication of at least one type of ascertaining device.

64. The method of claim 61, wherein the storing the one or more antenna assembly configuration parameters in association with at least one indication comprises:
storing the one or more antenna assembly configuration parameters in association with at least one indication of at least one measure of signal quality.

65. (canceled)

66. The method of claim 61, wherein the storing the one or more antenna assembly configuration parameters in association with at least one indication comprises:
storing the one or more antenna assembly configuration parameters in association with at least one indication of at least one counterpart fixed wireless node.

67. The method of claim 1, wherein the managing the one or more antenna assembly configuration parameters that are associated with the at least one orientation position of the at least one portable wireless node comprises:
linking the one or more antenna assembly configuration parameters with map data.

68. (canceled)

69. (canceled)

70. A system for facilitating wireless communication in conjunction with orientation position, the system comprising:
circuitry for obtaining one or more antenna assembly configuration parameters that are associated with at least one orientation position of at least one portable wireless node; and
circuitry for managing the one or more antenna assembly configuration parameters that are associated with the at least one orientation position of the at least one portable wireless node.

71-138. (canceled)

139. An arrangement for facilitating wireless communication in conjunction with orientation position, the arrangement comprising:
means for obtaining one or more antenna assembly configuration parameters that are associated with at least one orientation position of at least one portable wireless node; and
means for managing the one or more antenna assembly configuration parameters that are associated with the at least one orientation position of the at least one portable wireless node.

140-207. (canceled)
